(19) United States
(12) Patent Application Publication
(10) Pub. No.: US 2025/0337020 A1
(43) Pub. Date: Oct. 30, 2025

(54) ALKALI METAL OR ALLOY ANODE WITH UNIFORM LI PLATING AND STRIPPING INTERLAYER

(71) Applicant: Elevated Materials US LLC, Santa Clara, CA (US)

(72) Inventor: Subramanya P Herle, Santa Clara, CA (US)

(21) Appl. No.: 19/189,413

(22) Filed: Apr. 25, 2025

Related U.S. Application Data
(60) Provisional application No. 63/638,960, filed on Apr. 26, 2024.

(51) Int. Cl. H01M 10/0585; H01M 4/02; H01M 4/04; H01M 10/0562

(52) U.S. Cl. CPC H01M 10/0585; H01M 4/0404; H01M 2004/027; H01M 10/0562

(57) ABSTRACT

Anode film stacks incorporating a constriction susceptible interlayer or a plating and stripping enhancement layer are provided. The anode film stack enables production of alkali-metal anodes or alkali metal alloy anodes with uniform Li plating and stripping performance, which can be used in an energy storage devices, for example, a battery or a capacitor. Methods and systems for forming the anode film stack are also provided.

### CROSS-REFERENCE TO RELATED APPLICATIONS

This application claims the benefit of U.S. Provisional Application No. 63/638,960 filed Apr. 26, 2024, which is incorporated herein by reference in its entirety.

### BACKGROUND

### Field

The disclosure generally relates to lithium metal containing devices and methods for manufacturing lithium metal containing devices. More particularly, the disclosure relates to lithium metal anode device stacks for energy storage devices and a methods for manufacturing the same.

### Description of the Related Art

Rechargeable energy storage devices are currently becoming increasingly essential for many fields of everyday life. High-capacity energy storage devices incorporating alkali metals, such as lithium-ion (Li-ion) batteries, are used in a growing number of applications, including portable electronics, medical, transportation, grid-connected large energy storage, renewable energy storage, and uninterruptible power supply (UPS).

Therefore, there is a need for electrodes incorporating alkali metals and methods and apparatus for the deposition and processing of alkali metals used in energy storage devices.

### SUMMARY

The present disclosure generally relates to energy storage devices and methods and apparatus for manufacturing energy storage devices. More particularly, the present disclosure generally relates to electrodes and methods and apparatus for forming electrodes.

In one aspect, a method of making an electrode structure is provided. The method includes forming a film stack over a carrier substrate. Forming the film stack includes forming a plating and stripping enhancement film over the carrier substrate, the plating and stripping enhancement film comprising a constriction compliant material and forming an alkali metal-containing film on the plating and stripping enhancement film. The method further includes transferring the film stack from the carrier substrate to a flexible conductive substrate to form an anode film stack, wherein the alkali metal-containing film contacts the flexible conductive substrate in the anode film stack.

Implementations may include one or more of the following. The constriction compliant material is selected from oxides of Mg, oxides of aluminum, oxides of silicon, Ag, Al, Bi, M g, Sn, Zn, Cu, Si, alloys of Ag, Al, Bi, M g, Zn, Cu, Sn, Si, silica coated Ag, silica coated Bi, silica coated M g, silica coated Sn, or a combination thereof. The alkali metal-containing film is a lithium metal film. A release film is formed on the carrier substrate, the release film contacting the carrier substrate and the plating and stripping enhancement film. The method further comprises forming an interface film over the carrier substrate and forming a solid electrolyte film on the interface film, the interface film and the solid electrolyte film formed prior to the plating and stripping enhancement film. The interface film, the solid electrolyte film, and the plating and stripping enhancement film are formed using non-vacuum coating techniques. The alkali metal-containing film is formed using vacuum coating techniques. The carrier substrate comprises a material selected from polyethylene terephthalate (PET), polyethylene naphthalate (PEN), polyimide (PI), metallized plastic, or a combination thereof. Transferring the film stack from the carrier substrate to the flexible conductive substrate includes a lamination transfer process, a laser lift-off process, or both the lamination transfer process and the laser lift-off process. The interface films includes a material selected from lithium fluoride, lithium chloride, lithium iodide, lithium oxide, lithium sulfide, lithium nitride, lithium phosphide, or a combination thereof. The solid electrolyte film comprises a solid electrolyte selected from lithium super ionic CONductor (LISICON), lithium aluminum germanium phosphate (LAGP), lithium aluminum titanium phosphate (LATP), lithium lanthanum titanium oxide (LLTO), lithium lanthanum zirconium oxide (LLZO), lithium phosphorous oxynitride (LiPON), Li7P2S8I, Li6PS5Cl, Li3PS4 (LPS), Li3.5Ge0.25PS4, Li10GeP2S12 (LGPS), or a combination thereof.

In another aspect, an alkali metal-containing film stack is provided. The alkali metal-containing film stack includes a flexible carrier substrate and a film stack formed over the flexible carrier substrate. The film stack includes a plating and stripping enhancement film formed over the flexible carrier substrate, the plating and stripping enhancement film comprising a constriction compliant material, and an alkali metal-containing film formed on the plating and stripping enhancement film.

Implementations may include one or more of the following. The constriction compliant material is selected from oxides of Mg, oxides of aluminum, oxides of silicon, Ag, Al, Bi, M g, Zn, Cu, Sn, Si, alloys of Ag, Al, Bi, Mg, Zn, Cu, Sn, Si, silica coated Ag, silica coated Bi, silica coated Mg, silica coated Sn, or a combination thereof. The alkali metal-containing film is a lithium metal film. The alkali metal-containing film stack further includes a release film formed on the flexible carrier substrate, the release film contacting the flexible carrier substrate and the plating and stripping enhancement film. The film stack further includes a solid electrolyte film formed over the flexible carrier substrate and an interface film formed on the solid electrolyte film, the alkali metal-containing film formed on the interface film. The flexible carrier substrate includes a material selected from polyethylene terephthalate (PET), polyethylene naphthalate (PEN), polyimide (PI), metallized plastic, or a combination thereof. The interface film includes a material selected from lithium fluoride, lithium chloride, lithium iodide, lithium oxide, lithium sulfide, lithium nitride, lithium phosphide, or a combination thereof. The solid electrolyte includes a solid electrolyte selected from lithium super ionic CON ductor (LISICON), lithium aluminum germanium phosphate (LAGP), lithium aluminum titanium phosphate (LATP), lithium lanthanum titanium oxide (LLTO), lithium lanthanum zirconium oxide (LLZO), lithium phosphorous oxynitride (LiPON), Li7P2S8I, Li6PS5Cl, Li3PS4 (LPS), Li3.5Ge0.25PS4, Li10GeP2S12 (LGPS), or a combination thereof.

In yet another aspect, a lamination transfer system is provided. The lamination transfer system includes a lamination transfer chamber and a system controller. The system controller is configured to cause the lamination transfer chamber to perform a process, including conveying a film stack from a supply hub toward a pickup hub, the film stack comprising a flexible carrier substrate, a plating and stripping enhancement film formed over the flexible carrier substrate, an alkali metal-containing film formed on the plating and stripping enhancement film. The plating and stripping enhancement film includes a constriction compliant material. The process further includes contacting the film stack with a flexible conductive substrate, laminating the film stack to the flexible conductive substrate, and removing the flexible carrier substrate from the film stack.

Implementations may include one or more of the following. The constriction compliant material is selected from oxides of Mg, oxides of aluminum, oxides of silicon, Ag, Al, Bi, Mg, Zn, Cu, Sn, Si, alloys of Ag, Al, Bi, M g, Zn, Cu, Sn, Si, silica coated Ag, silica coated Bi, silica coated Mg, silica coated Sn, or a combination thereof. The alkali metal-containing film is a lithium metal film. The alkali metal-containing film stack further includes a release film formed on the flexible carrier substrate, the release film contacting the flexible carrier substrate and the plating and stripping enhancement film. The film stack further includes a solid electrolyte film formed over the flexible carrier substrate and an interface film formed on the solid electrolyte film, the alkali metal-containing film formed on the interface film. The flexible carrier substrate includes a material selected from polyethylene terephthalate (PET), polyethylene naphthalate (PEN), polyimide (PI), metallized plastic, or a combination thereof. The interface film includes a material selected from lithium fluoride, lithium chloride, lithium iodide, lithium oxide, lithium sulfide, lithium nitride, lithium phosphide, or a combination thereof. The solid electrolyte includes a solid electrolyte selected from lithium super ionic CON ductor (LISICON), lithium aluminum germanium phosphate (LA GP), lithium aluminum titanium phosphate (LATP), lithium lanthanum titanium oxide (LLTO), lithium lanthanum zirconium oxide (LLZO), lithium phosphorous oxynitride (LiPON), Li7P2S8I, Li6PS5Cl, Li3PS4 (LPS), Li3.5Ge0.25PS4, Li10GeP2S12 (LGPS), or a combination thereof.

In another aspect, a non-transitory computer readable medium has stored thereon instructions, which, when executed by a processor, causes the process to perform operations of the above apparatus and/or method.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a schematic cross-sectional view of an energy storage device incorporating an anode structure having a plating and stripping enhancement film in accordance with one or more implementations of the present disclosure.

FIG. 2A illustrates a schematic cross-sectional view of a dual-sided anode electrode structure incorporating a plating and stripping enhancement film in accordance with one or more implementations of the present disclosure.

FIG. 2B illustrates a schematic cross-sectional view of another dual-sided anode electrode structure incorporating a plating and stripping enhancement film in accordance with one or more implementations of the present disclosure.

FIG. 3 illustrates a flowchart showing selected operations of a method of forming an energy storage device incorporating a plating and stripping enhancement film in accordance with one or more implementations of the present disclosure.

FIGS. 4A-4F illustrate views of various stages of manufacturing an energy storage device according to the method of FIG. 3 in accordance with one or more implementations of the present disclosure.

FIG. 5 illustrates a flowchart showing selected operations of another method of forming an energy storage device incorporating a plating and stripping enhancement film in accordance with one or more implementations of the present disclosure.

FIGS. 6A-6F illustrate views of various stages of manufacturing an energy storage device according to the method of FIG. 5 in accordance with one or more implementations of the present disclosure.

FIG. 7 illustrates a flowchart showing selected operations of another method of forming an energy storage device incorporating a plating and stripping enhancement film in accordance with one or more implementations of the present disclosure.

FIGS. 8A-8F illustrate views of various stages of manufacturing an energy storage device according to the method of FIG. 7 in accordance with one or more implementations of the present disclosure.

FIG. 9 illustrates a flowchart showing selected operations of another method of forming an energy storage device incorporating a plating and stripping enhancement film in accordance with one or more implementations of the present disclosure.

FIGS. 10A-10D illustrate views of various stages of manufacturing an energy storage device according to the method of FIG. 9 in accordance with one or more implementations of the present disclosure.

FIG. 11 illustrates a schematic view of a lamination transfer apparatus in accordance with one or more implementations of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to energy storage devices and methods and apparatus for manufacturing energy storage devices. More particularly, the present disclosure generally relates to patterned electrodes and methods and apparatus for forming patterned electrodes.

Substrate independent direct transfer (SIDT) is a method for forming anode device stacks by transferring one or more layers or films including an alkali metal film, for example, a lithium-containing film, to a current collector in implementations where lithium metal functions as an anode or for pre-lithiating an anode film which is already formed on the current collector. The already formed anode film can include or be, but is not limited to, graphite, silicon, silicon graphite, silicon oxide graphite, silicon, metalized plastic, and copper. In SIDT processes, the alkali metal film is formed over a support film or carrier film composed of one or more materials such as a plastic, for example, polyethylene terephthalate (PET), paper, or a combination thereof. The materials on the carrier film are directly transferred to either a current collector or an anode film, if already present, for pre-lithiation. A release film may be formed between the alkali metal film and the carrier film. The release film enables transfer of the alkali metal film and other materials off of the carrier film and onto the current collector or anode film if already present.

During operation of an energy storage device including an alkali metal, for example, lithium, plating and stripping of the alkali metal at high current densities can lead to internal shorts that cause thermal runaway. Uniform plating and stripping of the alkali metal is preferable for long cycling of alkali-metal anodes or alkali metal-containing alloy anodes. For example, a lithium metal anode is surface protected and used in the battery and cycled under controlled conditions to eliminate shorting of the cell though dendrite growth. Typically, lithium metal is plated at C/7 rate and discharged at higher rates, for example, C/3, and we have seen below 700 cycling performance. Solid-state battery technology is nascent, and higher temperature cycling is needed to eliminate Li plating. For practical application, lithium metal fast charge/discharge capability is needed and current Li-anode technology is insufficient. In addition, there is currently no simple manufacturing path for manufacturing such a device stack.

In one or more implementations of the present disclosure, anode film stacks incorporating a constriction susceptible interlayer or a plating and stripping enhancement layer are provided. The anode film stack enables production of alkali-metal anodes or alkali metal alloy anodes with uniform Li plating and stripping performance, which can be used in an energy storage devices, for example, a battery or a capacitor. Methods and systems for forming the anode film stack are also provided.

In one or more implementations of the present disclosure, anode film stacks incorporating the constriction susceptible interlayer or the plating and stripping enhancement layer are produced using an SIDT process. The SIDT process enables production of an anode device stack which opens a high volume manufacturing path.

In one or more implementations, which can be combined with other implementations, the plating and stripping enhancement film may comprise, consist of, or consist essentially of a constriction compliant material. The constriction compliant material may comprise, consist of, or consist essentially of oxides of magnesium, oxides of aluminum, oxides of silicon, Ag, Al, Bi, Mg, Zn, Cu, Sn, Si, alloys of Ag, Al, Bi, Mg, Zn, Cu, Sn, Si, silica coated Ag, silica coated Bi, silica coated Mg, silica coated Sn, magnesium silicide (Mg2Si), or a combination thereof. The plating and stripping enhancement film may be selected from metals, alloys of metals, or chalcogenides of the metals. The plating and stripping enhancement film may be selected from Ag, Bi, Mg, Sn, Si, Ga, In, alloys of metals or chalcogenides of Ag, Bi, Mg, Zn, Cu, Sn, Si, Ga, In, or a combination thereof. The plating and stripping enhancement film may be or include one or more of a metal including Al, Au, Ag, Bi, Pt, Zn, Si, Sn, Mg, In, Ga, or Cu, alloys thereof, or a metal oxide including AlOx, CuO, ZnO, CoO, or MnO. The plating and stripping enhancement film may be or include one or more of powders such as Si (micron sized), MgO, AlOx or SiOx coated Ag, Al, Mg, Sn, Bi, combinations thereof, or alloys thereof. The plating and stripping enhancement film may be or include one or more of Si, SiOx, Si—C, Li—Si, Li—SiOx, Al, Ag, Li—Ag, Bi, carbon, combinations thereof, or alloys thereof. The plating and stripping enhancement film may be or include a particle coating incorporating particles of the constriction compliant materials.

In one or more implementations, which can be combined with other implementations, the plating and stripping enhancement film may be deposited using vacuum coating techniques or atmospheric coating techniques. by at least one process selected from the group of immersing, spin coating, dip coating, spray coating, doctor blade coating, slot-die coating, solution casting, drop coating, physical vapor deposition (PV D), chemical vapor deposition (CVD) , hot-wire CVD (HWCVD), atomic layer deposition (ALD), or combinations thereof.

In one or more implementations, which can be combined with other implementations, the plating and stripping enhancement film comprises, consists of, or consists essentially of powders of the constriction compliant material. The particles of the powder may be nanoscale particles. The nanoscale particles may have a diameter in a range from about 1 nm to about 100 nm, or in a range from about 1 nanometer to about 50 nanometers, or in a range from about 1 nanometer to about 5 nanometers. The particles of the powder may be microscale particles. The particles of the powder may include aggregated microscale particles. The microscale particles may have a diameter in a range from about 1 μm to about 15 μm or in a range from about 1 μm to about 15 μm.

In one or more implementations, which can be combined with other implementations, the particles may be applied by either wet application techniques or dry powder application techniques. Examples of suitable powder application techniques include but are not limited to electrostatic spraying techniques, thermal or flame spraying techniques, sifting techniques, fluidized bed coating techniques, slit coating techniques, roll coating techniques, and combinations thereof. Examples of suitable wet application techniques include but are not limited to slot die coating techniques, comma bar coating techniques, or gravure coating techniques.

In one or more implementations, which can be combined with other implementations, the powder is applied using roll coating techniques. The roll coating techniques uses a roller to apply the particles to the underlying film, for example, the alkali-metal containing film, the carrier film, or any other film on which the plating and stripping enhancement film is formed. The particles typically have a charge opposite to that of the area to be coated and the roller delivers the particles to that area with an opposite and attractive electric charge such that the particles uniformly coat the underlying surface.

In one or more implementations, which can be combined with other implementations, the powder/particles are mixed with a compatible electrolyte and/or solvent prior to deposition.

In one or more implementations, which can be combined with other implementations, the plating and stripping enhancement film is produced using a constriction susceptible anode material powder selected from silicon (micron sized), MgO, AlOx or SiOx coated Ag, Al, Mg, Sn, Bi or alloys etc., Mg2Si mixed with a binder and optionally conductive additive such as carbon is added to make a slurry with a solvent, preferably water and slot-die casted onto a plastic substrate (e.g., PET). The coated electrode is dried to remove the solvent and the roll is transferred to a roll-to-roll deposition system for lithium deposition over or on the plating and stripping enhancement film. The Li deposited roll is transferred to an SIDT tool and laminated onto a current collector, for example, a copper current collector, a stainless steel current collector, or a metallized plastic current collector.

In one or more implementations, which can be combined with other implementations, the alkali-metal or the alloy anode device stack further includes one or more solid electrolyte interface (SEI) films. The SEI films may be formed by coating a solid electrolyte (SE) slurry onto a carrier plastic film. Multiple SEI films may be co-deposited using appropriate coating methods for example, a co-extrusion process, followed by interlayer film deposition then lithium deposition before SIDT.

In one or more implementations, which can be combined with other implementations, the plating and stripping enhancement film is subjected to a post-deposition treatment process. The post-deposition treatment process can include a thermal treatment process or annealing process designed to accelerate absorption of lithium into the plating and stripping enhancement layer. Examples of the post-treatment process include annealing in a vacuum environment, laser heating in a controlled ambient (e.g., argon or vacuum), exposure to thermal energy and/or radiation energy, adjusting pressure to accelerate absorption during the process, or a combination thereof. Examples of thermal treatment processes include induction heating, infrared lamp heating, and laser treatment. The post-deposition treatment process can contribute to formation of an alloy from the material of the plating and stripping enhancement film with the material of the alkali metal-containing film.

It is noted that while the particular substrate on which some implementations described herein can be practiced is not limited, it is particularly beneficial to practice the implementations described on flexible substrates, including for example, web-based substrates, panels and discrete sheets. The flexible substrate can also be in the form of a foil, a film, or a thin plate.

It is also noted here that a flexible substrate or web as used within the implementations described herein can typically be characterized in that it is bendable. The term “web” can be synonymously used to the term “strip,” the term “flexible substrate,” or the term “flexible conductive substrate.” For example, the web as described in implementations herein can be a polymer material.

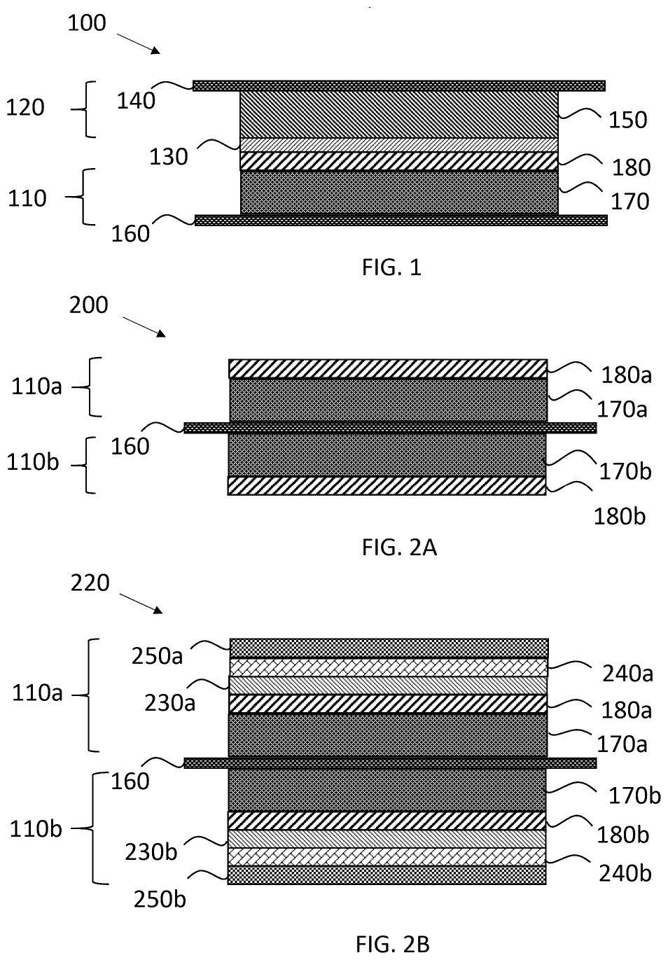

FIG. 1 illustrates a schematic cross-sectional view of one implementation of an energy storage device 100 incorporating an anode electrode structure having a plating and stripping enhancement film in accordance with one or more implementations of the present disclosure. The energy storage device 100 may be a solid-state energy storage device, a sodium-ion based storage device, or a lithium-ion based energy storage device. The energy storage device 100, even though shown as a planar structure, may also be formed into a cylinder by rolling the stack of layers; furthermore, other cell configurations (e.g., prismatic cells, button cells, or stacked electrode cells) may be formed. The energy storage device 100 includes an anode electrode structure 110 and a cathode electrode structure 120 with a separator film 130 positioned therebetween. In some implementations where the energy storage device 100 is a solid-state energy storage device, the separator film 130 may be replaced with a solid-electrolyte film. The cathode electrode structure 120 includes a cathode current collector 140 and a cathode film 150. The anode electrode structure 110 includes an anode current collector 160, an anode film 170, and a plating and stripping enhancement film 180. The anode film 170 can be or include an alkali metal film, an alloy of an alkali metal film, or both an alkali metal film and an alloy of an alkali metal film.

The cathode electrode structure 120 includes the cathode current collector 140 with the cathode film 150 formed on the cathode current collector 140. It should be understood that the cathode electrode structure 120 may include other elements or films.

The separator film 130 may include, a cellulose based substrate, for example, a blend of cellulose nanofibers and aramid fibers, by way of non-limiting example. The separator film 130 may include, a microporous polymeric separator including a polyolefin, by way of non-limiting example. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In some implementations, the polyolefin may be polyethylene (PE), polypropylene (PP), or a blend of PE and PP, or multi-layered structured porous films of PE and/or PP, for example, a tri-layer polypropylene/polyethylene/polypropylene separator. The separator film 130 may be or include a web-based substrate.

The current collectors 140, 160, on the cathode film 150 and the anode film 170, respectively, can be identical or different electronic conductors. In some implementations, at least one of the current collectors 140, 160 is a flexible substrate. In some implementations, the flexible substrate is a CPP film (i.e., a casting polypropylene film), an OPP film (i.e., an oriented polypropylene film), or a polyethylene terephthalate (“PET”) film (i.e., an oriented polyethylene terephthalate film). Alternatively, the flexible substrate may be a pre-coated paper, a polypropylene (PP) film, a PEN film, a poly lactase acetate (PLA) film, or a PVC film. Examples of metals that the current collectors 140, 160 may be comprised of include aluminum (Al), copper (Cu), zinc (Zn), nickel (Ni), cobalt (Co), manganese (Mn), chromium (Cr), stainless steel, clad materials, alloys thereof, or a combination thereof. In one or more implementations, which can be combined with other implementations, at least one of the current collectors 140, 160 is perforated. In one implementation, at least one of the current collectors 140, 160 is a metallized plastic substrate including a polymer substrate, for example, a PET film, coated with a metallic material. In one or more implementations, which can be combined with other implementations, the anode current collector 160 is a polymer substrate, for example, a PET film, coated with copper. In another implementation, the anode current collector 160 is a multi-metal layer on a polymer substrate. The multi-metal layer can be combinations of copper, chromium, nickel, etc. In one or more implementations, which can be combined with other implementations, the anode current collector 160 is a multi-layer structure that includes a copper-nickel cladding material. In one or more implementations, which can be combined with other implementations, the multi-layer structure includes a first layer of nickel or chromium, a second layer of copper formed on the first layer, and a third layer including nickel, chromium, or both formed on the second layer. In one or more implementations, which can be combined with other implementations, the anode current collector 160 is nickel coated copper. Furthermore, current collectors may be of any form factor (e.g., metallic foil, mesh foil, sheet, or plate), shape and micro/macro structure.

In one or more implementations, which can be combined with other implementations, the cathode current collector 140 is or includes aluminum. In one or more implementations, which can be combined with other implementations, the cathode current collector 140 comprises aluminum deposited on a polymer substrate, for example, a PET film. In one or more implementations, which can be combined with other implementations, the anode current collector 160 is or includes copper. In one implementation, the anode current collector 160 is stainless steel.

The cathode film 150 or cathode may be any material compatible with the anode and may include an intercalation compound, an insertion compound, or an electrochemically active polymer. Suitable intercalation materials include, for example, lithium-containing metal oxides, MoS₂, FeS₂, BiF₃, Fe₂OF₄, MnO₂, TiS₂, NbSe₃, LiCoO₂, LiNiO₂, LiMnO₂, LiMn₂O₄, V₆O₁₃ and V₂O₅. Suitable polymers include, for example, polyacetylene, polypyrrole, polyaniline, and polythiophene. The cathode film 150 or cathode may be made from a layered oxide, such as lithium cobalt oxide, an olivine, such as lithium iron phosphate, or a spinel, such as lithium manganese oxide. Exemplary lithium-containing oxides may be layered, such as lithium cobalt oxide (LiCoO₂), or mixed metal oxides, such as LiNiₓCo₁₋₂ₓMnO₂, LiNiMnCoO₂ (“NMC”), LiNi_{0.5}Mn_{1.5}O₄, Li(Ni_{0.8}Co_{0.15}Al_{0.05})O₂, LiMn₂O₄, and doped lithium rich layered-layered materials, wherein x is zero or a non-zero number. Exemplary phosphates may be iron olivine (LiFePO₄) and it is variants (such as LiFe₍₁₋ₓ₎MgₓPO₄) , LiMoPO₄, LiCoPO₄, LiNiPO₄, Li₃V₂(PO₄)₃, LiVOPO₄, LiMP₂O₇, or LiFe_{1.5}P₂O₇, wherein x is zero or a non-zero number. Exemplary fluorophosphates may be LiVPO₄F, LiAlPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃.

The anode electrode structure 110 includes the anode current collector 160 with the anode film 170 formed on the anode current collector 160 and the plating and stripping enhancement film 180 formed on the anode film 170. The anode electrode structure 110 may further include additional layers, which are not shown for the sake of brevity. It should be noted that although the plating and stripping enhancement film 180 is shown as a separate layer, in some implementations, the plating and stripping enhancement film 180 forms an alloy with the anode film 170 and thus is not a separate film.

The anode film 170 may be any material compatible with the cathode film 150. The anode film 170 may be patterned. The anode film 170 can be or include alkali metals, alkaline earth metals, and alloys thereof. The anode film 170 may have an energy capacity greater than or equal to 372 mAh/g, preferably ≥700 mAh/g, and most preferably ≥700 mA h/g. The anode film 170 may be constructed from graphite, silicon, silicon-containing graphite, silicon oxide, alkali metals, for example, alkali metal foil or an alkali metal alloy foil (e.g. lithium aluminum alloys or sodium aluminum alloys), or a mixture of an alkali metal and/or an alkali metal alloy and materials such as carbon (e.g. coke, graphite), nickel, copper, tin, indium, silicon, oxides thereof, or a combination thereof. Suitable lithium-containing metal films include lithium metal, lithium metal foil, or a lithium alloy foil (e.g. lithium aluminum alloys), or a mixture of a lithium metal and/or lithium alloy and materials such as carbon (e.g. coke, graphite), nickel, copper, tin, indium, silicon, oxides thereof, or a combination thereof. Suitable sodium-containing metal films include sodium metal, sodium metal foil or a sodium alloy foil (e.g. sodium aluminum alloys), or a mixture of a sodium metal and/or sodium alloy and materials such as carbon (e.g. coke, graphite), nickel, copper, tin, indium, tellurium, silicon, oxides thereof, or a combination thereof. The anode film 170 can include intercalation compounds containing lithium, sodium, or insertion compounds containing lithium or sodium. In one or more implementations, which can be combined with other implementations, the anode film 170 is a lithium metal film or a sodium metal film. In some implementations, wherein the anode film 170 includes lithium metal or sodium metal, the lithium metal or sodium metal may be deposited using the methods described herein.

The plating and stripping enhancement film 180 may enable uniform lithium plating and stripping performance in a formed energy storage device. The plating and stripping enhancement film 180 may comprise, consist of, or consist essentially of a constriction compliant material. The constriction compliant material may comprise, consist of, or consist essentially of oxides of magnesium, oxides of aluminum, oxides of silicon, Ag, Al, Bi, Mg, Zn, Cu, Sn, Si, alloys of Ag, Al, Bi, Mg, Zn, Cu, Sn, Si, silica coated Ag, silica coated Bi, silica coated Mg, silica coated Sn, magnesium silicide (Mg2Si), or a combination thereof. The plating and stripping enhancement film 180 may be selected from metals, alloys of metals, or chalcogenides of the metals. The plating and stripping enhancement film 180 may be selected from Ag, Bi, Mg, Zn, Cu, Sn, Si, Ga, In, alloys of metals or chalcogenides of Ag, Bi, Mg, Zn, Cu, Sn, Si, Ga, In, or a combination thereof. The plating and stripping enhancement film 180 may be or include at least one of: a metal including Al, Au, Ag, Bi, Zn, Cu, Pt, Zn, Si, Sn, Mg, In, Ga, or Cu, alloys thereof, or a metal oxide including AlOx, CuO, ZnO, CoO, or MnO. The plating and stripping enhancement film 180 may be deposited by vapor coating techniques or atmospheric coating techniques.

FIG. 2A illustrates a schematic cross-sectional view of an anode electrode structure 200 incorporating a plating and stripping enhancement film 180 in accordance with one or more implementations of the present disclosure. Note in FIG. 2A that the anode current collector 160 is shown to extend beyond the stack, although it is not necessary for the anode current collector 160 to extend beyond the stack, the portions extending beyond the stack may be used as tabs. Although the anode electrode structure 200 is depicted as a dual-sided electrode structure, it should be understood that the implementations described herein also apply to single-sided electrode structures.

The anode electrode structure 200 has the anode current collector 160 and an anode film stack 110a-b formed on opposing sides of the anode current collector 160. In one or more implementations, which can be combined with other implementations, the anode film stack 110a-b includes the anode film 170a-b and the plating and stripping enhancement film 180a-b formed on each of the anode films 170a-b.

FIG. 2B illustrates a schematic cross-sectional view of another anode electrode structure 220 incorporating a plating and stripping enhancement film 180a-b in accordance with one or more implementations of the present disclosure. Similar to the anode electrode structure 200, the anode electrode structure includes the anode current collector 160 and the anode film stack 110a-b formed on opposing sides of the anode current collector 160. The anode electrode structure 220 includes anode film stacks 110a-b. The anode film stacks 110a-b include the anode film 170a-b and the plating and stripping enhancement film 180a-b formed on each of the anode films 170a-b. The anode film stacks 110a-b further include a solid electrolyte film 230a-b, an interface film 240a-b formed on or over the solid electrolyte film 230a-b, and optionally a passivation film 250a-b formed on or over the interface film 240a-b. The solid electrolyte film 230a-b may adjacent to and/or contact the plating and stripping enhancement film 180a-b as shown in FIG. 2B.

The solid electrolyte film 230a-b may comprise any suitable material that is compatible with the targeted ion conducting. In some implementations, the solid electrolyte film 230a-b can include or be a metal salt, such as lithium salt. The lithium salt can be one or more of LiPF₆, LiASF₆, LiCF₃SO₃, LiN(CF₃SO₃)₃, LiBF₆, LiClO₄BETTE electrolyte, or combinations thereof. The electrolyte can be in a gel or polymer matrix medium.

In one or more implementations, the solid electrolyte film 230a-b can be or include materials selected from fluorocarbons (PTFE, PVDF), LiF, Li3N, Li2O, Li2CO3, Mg0, AlOx, AlHO2, RENiO3 (RE=rare earth), BN, BaTiO3, Li4Ti5O12, ZrO2, TiO2, silicon doped lithium tantalum phosphates, for example, Li(1+x)Ta2P(1−x) SixO8, Li1.5Ta2P0.5Si0.5O8, lithium tantalum phosphates, for example, LiTa2PO8 (LTPO), Li2Ta2SiO8 (LTSO), Li0.34La0.56TiO3, lithium aluminum titanium phosphates, for example, Li1.3Al0.3Ti1.7(PO4)3 (LATP), lithium aluminum germanium phosphates, for example, Li1.3Al0.3Ge1.7(PO4)3 (LAGP), garnet Li7La3Zr2O12 (LLZO), Li2−xLa (1+x)/3M2O6F (M=Nb, Ta), LiTa2PO8, or a combination thereof. In one or more implementations, the solid electrolyte film 230a-b can be or include materials selected from lithium super ionic CON ductor (LISICON), lithium aluminum germanium phosphate (LAGP), lithium aluminum titanium phosphate (LATP), lithium lanthanum titanium oxide (LLTO), lithium lanthanum zirconium oxide (LLZO), lithium phosphorous oxynitride (LiPON), Li7P2S8I, Li6PS5Cl, Li3PS4 (LPS), Li3.5Ge0.25PS4, Li7GeP2S12 (LGPS), or a combination thereof.

In one or more implementations, the solid electrolyte film 230a-b may be formed using atmospheric coating techniques. Suitable coating techniques include, but are not limited to, a slot-die coating process, a doctor-blade coating process, a three-dimensional (3D) printing process, or a combination thereof. In one or more alternative implementations, the solid electrolyte film 230a-b may be formed using vacuum coating techniques.

The interface film 240a-b may include any suitable material that is compatible with the targeted ion conducting. In some implementations, the interface layer can include or be a material selected from lithium fluoride, lithium chloride, lithium iodide, lithium oxide, lithium sulfide, lithium nitride, lithium phosphide, or a combination thereof.

In one or more implementations, the interface film 240a-b may be formed using atmospheric coating techniques. Suitable coating techniques include, but are not limited to, a slot-die coating process, a doctor-blade coating process, a three-dimensional (3D) printing process, or a combination thereof. In one or more alternative implementations, the interface film 240a-b may be formed using vacuum coating techniques.

The solid electrolyte film 230a-b and the interface film 240a-b can synergistically provide a thermodynamically stable interface.

The passivation film 250a-b (if present) is formed on the interface film 240a-b. In some implementations, the one or more protective film(s) are ion-conducting films. In some implementations, the passivation film 250a-b are permeable to at least one of lithium ions and lithium atoms. The passivation film 250a-b provides surface protection of the interface film 240a-b and the underlying anode film 170, which allows for handling of the anode film 170 in a dry room. In some implementations where the energy storage device 100 is a solid-state energy storage device, the passivation film 250a-b contributes to the formation of an improved SEI layer and thus improves device performance. The passivation film 250a-b, which can include a release layer or other passivation material such as one or more of a lithium fluoride film, a lithium carbonate film, or both a lithium fluoride and a lithium carbonate film.

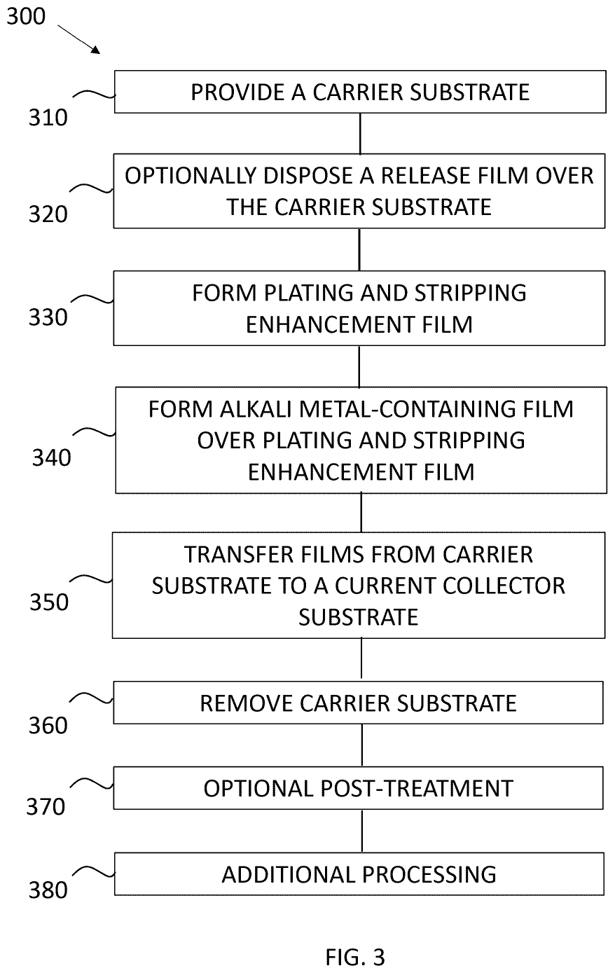

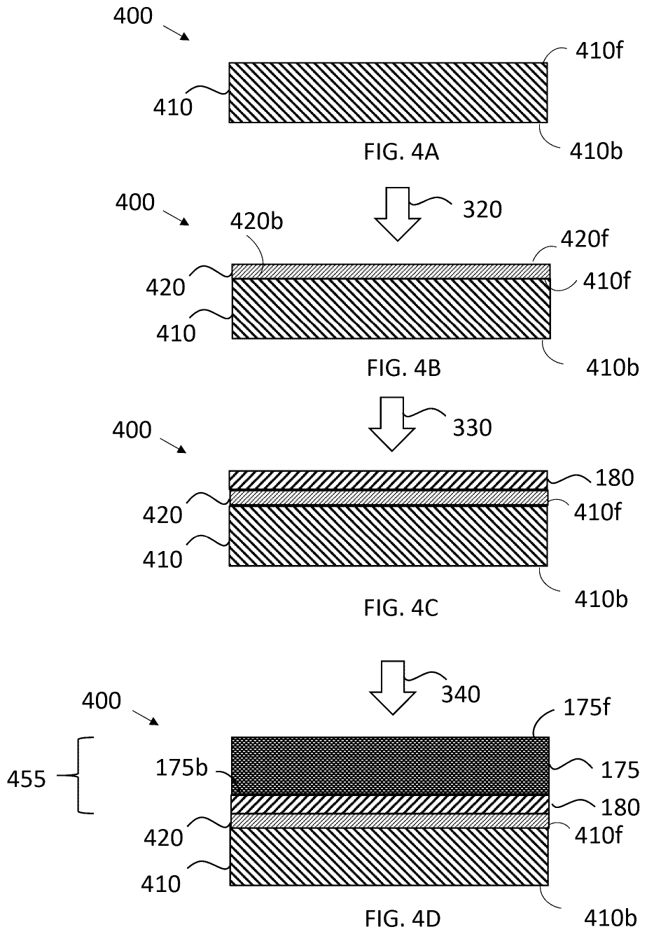

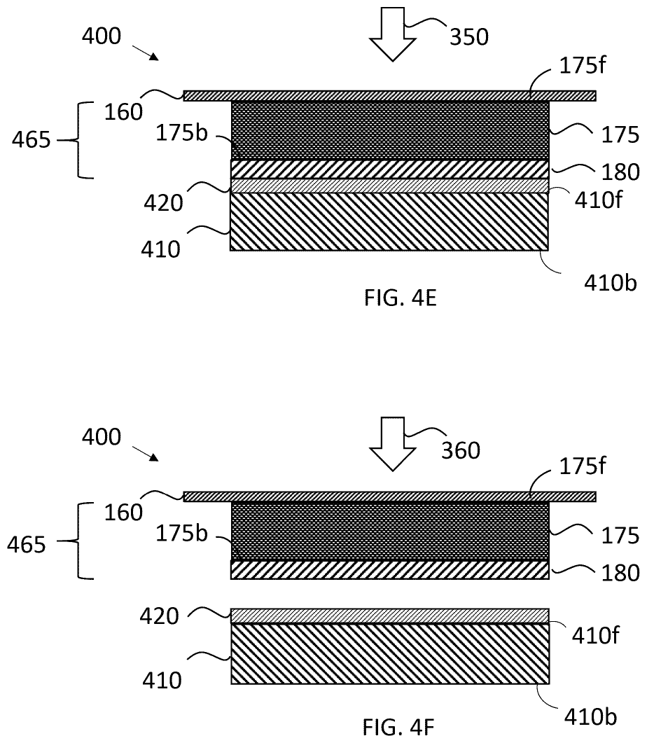

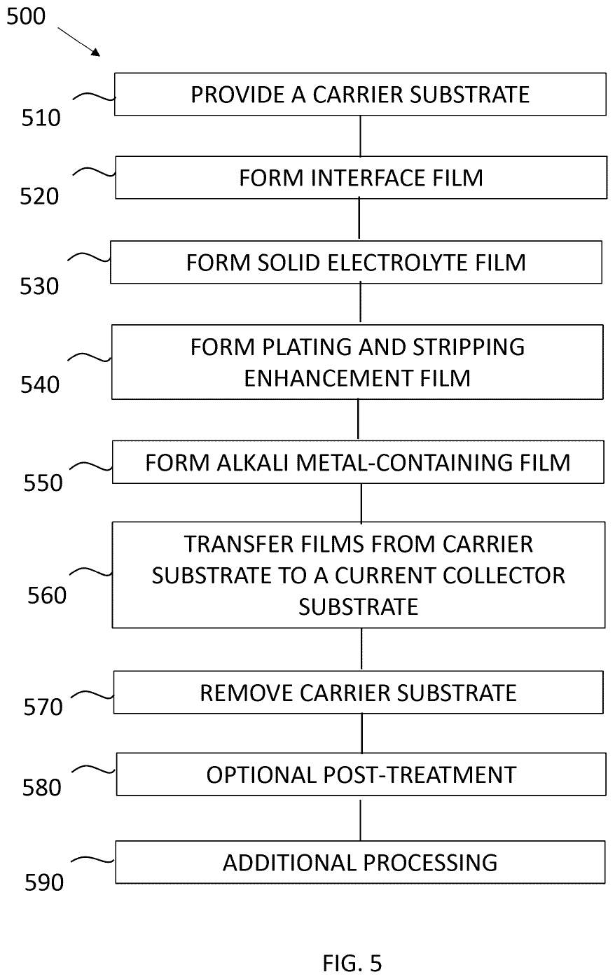

FIG. 3 illustrates a flow chart of a method 300 for manufacturing an energy storage device in accordance with one or more implementations of the present disclosure. FIGS. 4A-4F illustrate views of various stages of manufacturing an energy storage device in accordance with one or more implementations of the present disclosure. Although FIGS. 4A-4F are described in relation to the method 300, it will be appreciated that the structures disclosed in FIGS. 4A-4F are not limited to the method 300, but instead may stand alone as structures independent of the method 300. Similarly, although the method 300 is described in relation to FIGS. 4A-4F, it will be appreciated that the method 300 is not limited to the structures disclosed in FIGS. 4A-4F but instead may stand alone independent of the structures disclosed in FIGS. 4A-4F. It should be understood that FIGS. 4A-4F illustrate only partial schematic views of the energy storage device structure 400, and the energy storage device structure 400 may contain any number of additional layer and/or additional materials common to energy storage devices, which are not shown for the sake of brevity. It should also be noted that although the method 300 illustrated in FIG. 3 is described sequentially, other process sequences that include one or more operations that have been omitted and/or added, and/or have been rearranged in another desirable order, fall within the scope of the implementations of the disclosure provided herein.

Referring to FIG. 4A, at operation 310 a flexible carrier substrate 410 is provided. The flexible carrier substrate 410 has a frontside 410f (also referred to as a front surface) and a backside 410b (also referred to as a back surface) opposite the frontside 410f. The flexible carrier substrate 410 may comprise any suitable material that is compatible with the targeted processing conditions. In some implementations, the flexible carrier substrate 410 includes a plurality of sub-layers. In one or more implementations, which can be combined with other implementations, the flexible carrier substrate 410 can be or include, one or more layers selected from plastic, polymer materials, metallized plastic, metals, paper, multilayers thereof, or a combination thereof. Example of suitable polymer materials include polyethylene terephthalate (PET), polyethylene naphthalate (PEN), polyimide (PI), poly(methyl methacrylate) (PMMA), cellulose tri-acetate (TAC), polypropylene (PP), polyethylene (PE), polycarbonates (PC), multilayers thereof, or a combination thereof.

In one or more implementations, which can be combined with other implementations, the flexible carrier substrate 410 has a thickness in a range from about 1 micron to about 70 microns, or in a range from about 1 micron to about 70 microns, or in a range from about 7 microns to about 50 microns, or in a range from about 25 microns to about 50 microns.

Referring to FIG. 4B, optionally, at operation 320 a release film 420 is formed on the frontside 410f of the flexible carrier substrate 410. In one or more implementations, which may be combined with other implementations, the release film 420 and the flexible carrier substrate 410 are pre-fabricated. The release film 420 has a frontside 420f (also referred to as a front surface) and a backside 420b (also referred to as a back surface) opposite the frontside 420f. In one or more implementations, the release film 420 is deposited on the frontside 410f of the flexible carrier substrate 410 such that the backside 420b of the release film 420 contacts the frontside 410f of the flexible carrier substrate 410. Any suitable process may be used to form the release film 420 on the frontside of the flexible carrier substrate 410. The release film 420 may be deposited using atmospheric coating techniques, for example, coating techniques performed in atmosphere.

The release film 420 may be or include any material suitable for releasing the anode device stack from the flexible carrier substrate 410 during the SIDT process. The release film 420 may be or include polymer release layers (for example, plastics, silicone, polymethylacrylate (PMA), polyethylene terephthalate (PET), fluorocarbons, polyvinylidene fluoride (PVDF), polytetrafluoroethylene (PTFE), etc.), poly(olefin sulfones), organic materials, inorganic materials, for example, silicone, among other materials. In some implementations, which can be combined with other implementations, the release film 420 includes one or more nanosheets, such as one or more two-dimensional (2D) materials. In one or more implementations, which can be combined with other implementations, the release layer has a thickness of about 1 nm to about 500 nm, such as about 7 nm to about 300 nm, such as about 50 to about 200 nm. In some implementations, the release layer includes a plurality of sub-layers, each layer having a thickness of about 5 nm or less.

The release film 420 can be deposited using wet-chemistry coating processes, for example, slot-die coating techniques, comma bar coating techniques, or gravure coating techniques, or vacuum deposition techniques as described.

The release film 420 may be or include inorganic materials, for example, BN, AIOx, AIOOH, Al, or a combination thereof. In particular implementations, the release film 420 includes a multi-layer structure, for example, a multilayer structure of Al/AlOx/AlOOH. Inorganic based release layers can be deposited using vapor deposition techniques, for example, PVD techniques such as sputter deposition and electron beam deposition techniques.

In one or more implementations, the polymer material of the release film 420 is selected so that the SIDT stack can be debonded from flexible carrier substrate 410 by photo-initiated lift-off wherein the polymer material interacts with photons entering from the flexible carrier substrate 410.

In one or more implementations, the release film 420 can be or include a polymer material that is capable of photoinduced depolymerization. In one or more implementations, the polymer material can be or include a poly(olefin sulfone) material capable of photoinduced depolymerization. The poly(olefin sulfone) may be combined with photobase generators (PBGs). The poly(olefin sulfone) can be doped with a photosensitizer, for example, pyridine N-oxide. The depolymerization process can be induced by, for example, X-rays, electron-beam irradiation, or low-energy irradiation. Suitable poly(olefin sulfone) materials include poly(1-butene sulfone) (PBS), poly(1-pentane sulfone) (PPS), poly(1-hexane sulfone) (PHS), poly(1-octene sulfone) (POS), poly cyclopentene sulfone), poly(2-methyl-1-butene sulfone) (PM BS), poly(2-methyl-1-pentene sulfone) (PM PS), poly(2-methyl 1-hexene sulfone) (PM HS), poly(2-methyl-1-nonene sulfone) (PM NS), poly(cyclohexene sulfone), or a combination thereof.

In one or more implementations, the carrier substrate 410 undergoes a direct fluorination process that fluorinates the carrier substrate 410. The direct fluorination process may be performed either in lieu of or in combination with the release layer deposition process of operation 320. The direct fluorination process may include exposing the carrier substrate 410 to a fluorine-containing gas to form a fluorinated layer on the carrier substrate 410. The direct fluorination process is a diffusion-controlled process where the rate of formation of a fluorinated layer is limited by the rate of penetration of fluorine into the surface of the carrier substrate 410.

After operation 320 and prior to operation 330, the partially formed device structure 400 may be transferred into a vacuum coating system.

Referring to FIG. 3, optionally at operation 330, the plating and stripping enhancement film 180 is formed over or on the release film 420 (if present) or the flexible carrier substrate 410. The plating and stripping enhancement film 180 is disposed between the release film 420 and the subsequently deposited alkali metal-containing film 175. The plating and stripping enhancement film 180 may be deposited under vacuum or atmospheric conditions. The plating and stripping enhancement film 180 may be deposited using vacuum-coating techniques or atmospheric coating techniques.

Referring to FIG. 4D, at operation 340, an alkali metal-containing film 175 is formed over the plating and stripping enhancement film 180. The anode film 170 may be or include the alkali metal-containing film 175. The alkali metal-containing film 175 includes a frontside 175f (also referred to as a front surface) and a backside 175b (also referred to as a back surface) opposite the frontside 175f. In some implementations, where any of the solid electrolyte interface film 230 and the one or more interface films 240 are present, the alkali metal-containing film 175 may be formed directly on the underlying layers, for example, any of the solid electrolyte interface film 230 and the one or more interface films 240. In some implementations, where the solid electrolyte interface film 230 and the one or more interface films 240 are not present as is shown in FIG. 4D, the alkali metal-containing film 175 is formed directly on the plating and stripping enhancement film 180. The alkali metal-containing film 175 may be or include lithium. The alkali metal-containing film 175 may be deposited under vacuum. The alkali metal-containing film 175 may be deposited under vacuum in a roll-to-roll deposition system. The alkali metal-containing film 175 may be deposited via a physical vapor deposition process, for example, an evaporation process or a sputtering process. The evaporation process may be an electron beam evaporation process or a thermal evaporation process.

Referring to FIG. 4D, the plating and stripping enhancement film 180 and the alkali metal-containing film 175 form an SIDT film stack 455. Although the SIDT film stack 455 is shown as including the release film 420, the SIDT film stack 455 may or may not contain the release film 420.

The SIDT film stacks described herein are formed such that the alkali metal-containing film 175, e.g., the lithium film, is deposited last on the SIDT film stack. Depositing the lithium layer last enables forming the film stack without damaging the lithium layer, which typically has a lower melting point relative to other materials that are formed in energy storage device. Conventional methods of forming energy storage devices include direct deposition of molten lithium onto the current collector in lithium metal anode formation or onto the anode material in pre-lithiation implementations. These methods further include maintaining the underlying substrate as the lithium layer is formed to prevent damage to the lithium. In contrast, the SIDT film stack 455 and methods described herein, enable forming the alkali metal-containing film 175 last prior to transferring the SIDT film stack 455 to the current collector during operation 350.

In some implementations, which can be combined with other implementations, a passivation layer can optionally be included in the SIDT film stack 455. In some implementations, the passivation layer includes a carbonate of the alkali metal in the alkali metal-containing film 175. In some implementations, which can be combined with other implementations, the alkali metal-containing film 175 is a lithium layer and the passivation layer comprises lithium carbonate. The passivation layer can be formed by exposure of the alkali metal-containing film 175 to carbon dioxide. In some implementations, the alkali metal-containing film 175 is exposed to carbon dioxide in the presence of heat. Without wishing to be bound by theory, it is believed that the carbon dioxide reacts with the alkali metal to form a thin layer of alkali metal carbonate on the exposed surface of the alkali metal-containing film 175. In some implementations, the carbonated alkali metal passivation layer, for example, the lithium carbonate passivation layer, can have a thickness ranging from about 50 nm to about 70 nm. The carbonated alkali metal passivation layer can serve as a protective layer for the alkali metal-containing film 175. For example, the carbonated alkali metal passivation layer can protect the alkali metal-containing film 175 from oxidation and damage during storage and shipping.

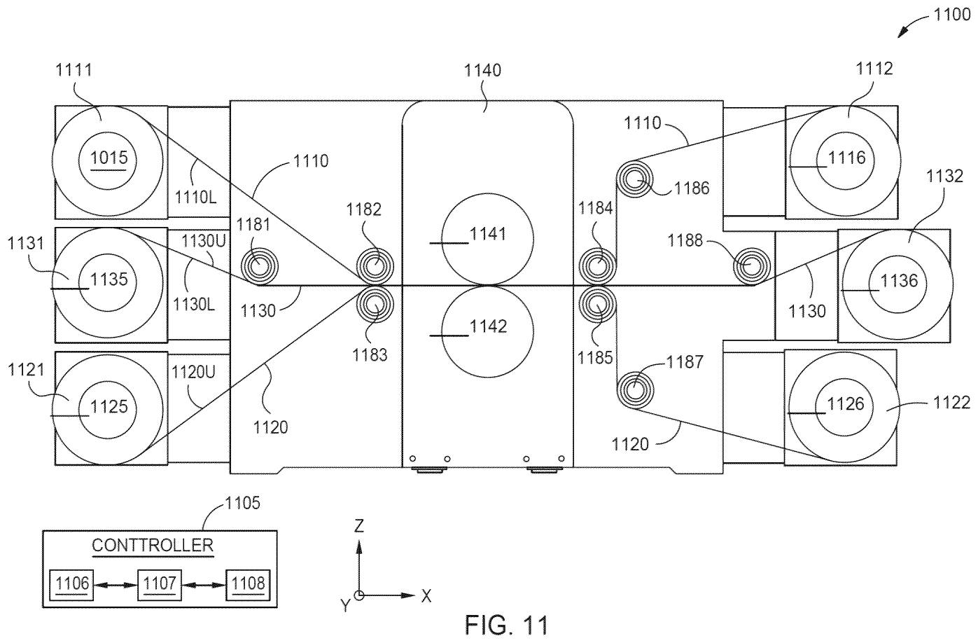

After operation 340 and prior to operation 350, the device structure 400 including the SIDT film stack 455 may be transferred from a vacuum coating system, for example, from a flexible substrate coating apparatus to a lamination transfer apparatus, for example, the lamination transfer system 1100 shown in FIG. 11.

Referring to FIG. 4E, at operation 350, the SIDT film stack 455 is transferred from the carrier substrate 410 to the anode current collector 160 to form an anode film stack 465. The transfer process includes applying the anode current collector 160 to the frontside 175f of the alkali metal-containing film 175 during operation 350 followed by removal of the carrier substrate 410 and optionally the release film 420 from the plating and stripping enhancement film 180 to form the anode film stack 465 at operation 360. Transferring the SIDT film stack 455 from the carrier substrate 410 to the anode current collector 160 may include a lamination transfer process, a laser lift-off process, or both a lamination transfer process and a laser lift-off process.

The lamination transfer process of operation 350 may include applying pressure to one or more of the SIDT film stack 455 and the carrier substrate 410 to laminate the SIDT film stack 455 to the carrier substrate 410. In some implementations, where operation 350 is performed in a roll-to-roll tool, web tension is sufficient to laminate the SIDT film stack 455 to the carrier substrate 410 and additional pressure is minimal or not needed. In some implementations, where additional pressure is used to laminate the SIDT film stack 455 to the carrier substrate 410, the lamination process includes pressing the SIDT film stack 455 to the carrier substrate 410 with a magnitude of pressure sufficient to attach the alkali metal-containing film 175 to the anode current collector 160 without damaging the alkali metal-containing film 175. In other words, the pressure is such that the alkali metal-containing film 175 is not mechanically destroyed or degraded, such as by cracking or crushing. Pressure may be applied using any suitable techniques. In one or more implementations, pressure is applied via a calendering process. The calendering process may include using a pair of calendering rollers. For example, pressure may be applied to a backside of the carrier substrate 410 and a backside of the anode current collector 160. In one or more other implementations, pressure is applied by a vacuum source. In one or more other implementations, the pressure is external pressure.

The laser lift-off process of operation 350 may include exposing portions of the alkali metal-containing film 175 to a laser activation process. The laser lift-off process of operation 350 includes exposing the carrier substrate 410 having the alkali metal-containing film 175 formed thereon to a laser. In one or more implementations, during the laser lift-off process, one or more lasers provided by one or more laser sources is directed through the backside of the carrier substrate 410 to activate the interface of the anode film stack 465 and the carrier substrate 410, for example, the interface of the plating and stripping enhancement film 180 and the carrier substrate 410 or the interface of the plating and stripping enhancement film 180 and the release film 420 (if present). The laser can be directed through the backside of the carrier substrate 410, for example, from the PET side.” Exposure to the laser can activate not only a surface of the plating and stripping enhancement film 180 but also a portion of the carrier substrate 410 and/or the release film 420. For example, exposure to the laser can activate one or more of a portion of the anode film stack 465, the release film 420, and the carrier substrate 410. For example, the laser can activate a portion of the release film 420, a portion of the carrier substrate 410 if the release film 420 is not present, or both a portion of the carrier substrate 410 and the release film 420. The laser lift-off process can create a void volume between the anode film stack 465 and the carrier substrate 410. The void volume can make separation of the anode film stack 465 from carrier substrate 410 during operation 360 easier.

Referring to FIG. 4F, at operation 360, the carrier substrate 410 is removed or peeled away from the anode film stack 465. In one or more implementations, which can be combined with other implementations, during operation 360 the release film 420 remains or partially remains on the carrier substrate 410 after operation 360 as is shown in FIG. 4F. Alternatively, in other implementations, the release film 420 is transferred or partially transferred with the anode film stack 465.

Optionally, at operation 370, the anode film stack 465 may be subjected to a post-treatment process. The post-treatment process can be performed to activate the alkali metal containing layer, to accelerate absorption of the alkali metal, for example, lithium, into the plating and stripping enhancement layer, or a combination of both. The post-treatment process of operation 370 may be performed prior to removal of the carrier substrate at operation 360, during removal of the carrier substrate at operation 360, or subsequent to removal of the carrier substrate at operation 360.

The post-treatment process of operation 370 can include a thermal treatment process or annealing process designed to accelerate absorption of lithium into the plating and stripping enhancement layer. Examples of the post-treatment process of operation 370 include annealing in a vacuum environment, laser heating in a controlled ambient (e.g., argon or vacuum), exposure to thermal energy and/or radiation energy, adjusting pressure to accelerate absorption during the process, or a combination thereof. Examples of thermal treatment processes include induction heating, infrared lamp heating, and laser treatment. During operation 370, heat or thermal energy can be applied to the anode film stack 465.

The conditions of the post-treatment process of operation 370 can be selected such that the anode film stack 465 is heated to a temperature below the melting point of the device structure 400 but high enough to accelerate diffusion of lithium from the alkali metal-containing film 175 into the plating and stripping enhancement film 180. The temperature of the post-treatment process of operation 370 can be within in a range from about room temperature (e.g., 22-24 degrees Celsius) to about 200 degrees Celsius. The temperature of the post-treatment process of operation 370 can be at or around room temperature. The temperature of the post-treatment process of operation 370 can be less than or equal to 180 degrees Celsius, for example, within a range from at or around room temperature to about 180 degrees Celsius. The temperature of the post-treatment process of operation 370 can be less than or equal to 150 degrees Celsius, for example, within a range from at or around room temperature to about 150 degrees Celsius. The temperature of the post-treatment process of operation 370 can be less than or equal to 130 degrees Celsius, for example, within a range from at or around room temperature to about 130 degrees Celsius. The temperature of the post-treatment process of operation 370 can be less than or equal to 80 degrees Celsius, for example, within a range from at or around room temperature to about 80 degrees Celsius. The temperature of the post-treatment process of operation 370 can be less than or equal to 60 degrees Celsius, for example, within a range from at or around room temperature to about 60 degrees Celsius. The anode film stack 465 can be heated to a temperature within a range from about room temperature to about 200 degrees Celsius, more narrowly within a range from about room temperature to about 180 degrees Celsius, more narrowly within a range from about 50 degrees Celsius to about 130 degrees Celsius, and more narrowly within a range from about 50 degrees Celsius to about 60 degrees Celsius.

For the vacuum annealing, the electrode structure (and hence the pre-lithiation layer deposited thereover) can be heated to an annealing temperature for a predetermined period of time. A ny suitable annealing temperature can be used. The annealing temperature can be within a range from about room temperature (e.g., 22-24 degrees Celsius) to about 200 degrees Celsius or any of the other ranges described with respect to operation 370. The vacuum annealing can occur for about 15 minutes to about 60 minutes. The vacuum annealing can occur for 5 minutes or more at ambient pressure. The vacuum annealing can occur in numerous environments. The vacuum annealing can occur in a vacuum environment. The vacuum annealing can occur in an inert gas environment, for example, argon, helium, neon, or a combination thereof. The vacuum annealing can occur in an environment of argon.

The post-treatment process of operation 370 can be performed under atmospheric conditions, near atmospheric conditions, or vacuum conditions. The post-treatment can be carried out in a vacuum environment with an environment of 1×10⁻² mbar to about 1×10⁻⁶ mbar (e.g., 1×10⁻³ or below; 1×10⁻⁴ or below). For some post-treatment vacuum processes, the pressure in the processing chamber during operation 370 can be below atmospheric pressure (e.g., 1013 mbar), for example, from about −2 mbar (e.g., −1500 mTorr) to about −25 mbar (e.g., −18751 mTorr). For some post-treatment processes performed at positive pressure, the pressure in the processing chamber during operation 370 can be performed within a range from about 10 mTorr to about 50 mTorr.

In one embodiment for the laser heating, the electrode structure (and hence the pre-lithiation layer deposited thereover) is exposed to radiant energy from a laser source to heat the electrode structure for a predetermined period of time. At least portions of the electrode structure can be annealed with the laser in a controlled ambient. The laser heating can occur in numerous environments. In one embodiment, the laser heating occurs in a vacuum environment. In another embodiment, the laser heating occurs in an inert gas environment. In another embodiment, the laser heating occurs in an environment of argon.

In one embodiment, for the thermal heating, the electrode structure (and hence the pre-lithiation layer deposited thereover) is exposed to radiant energy. Any suitable thermal heating temperature can be used. The thermal heating temperature can be within in a range from about room temperature (e.g., 22-24 degrees Celsius) to about 200 degrees Celsius or any of the other ranges described with respect to operation 370. The thermal heating can be performed by exposing the electrode structure to a heat source, for example, a lamp or heating assembly formed therein with an optional microwave generator coupled thereto. The microwave power applied during thermal/annealing process may gently heat/thermal process the electrode structure without adversely damaging the anode material or other film structures present in the electrode structure.

At operation 380, the anode film stack 465 may be subject to additional processing. For example, the anode film stack 465 may be integrated with one or more of the cathode electrode structure 120 and the separator film 130 to form an energy storage device, such as the energy storage device 100 shown in FIG. 1.

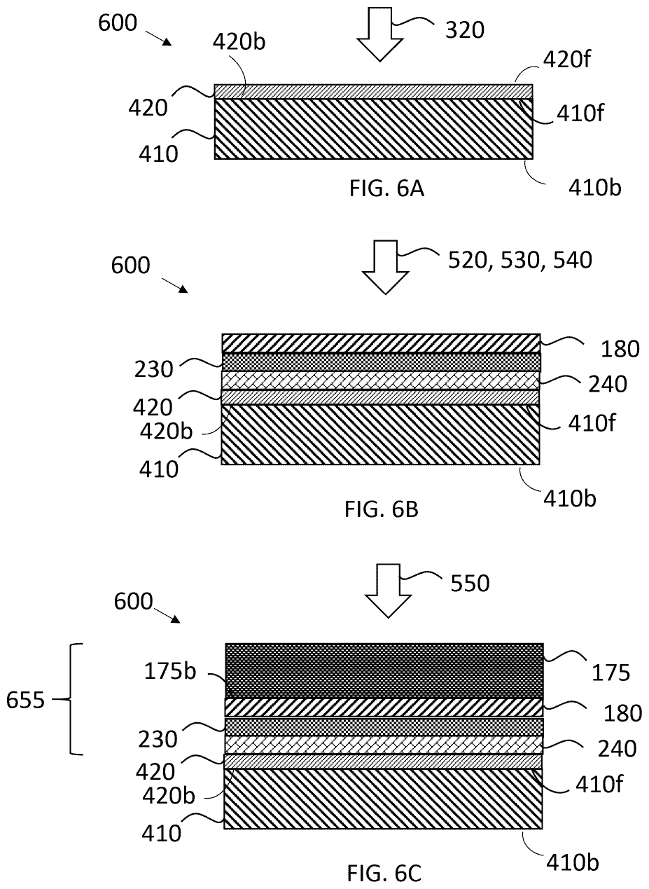

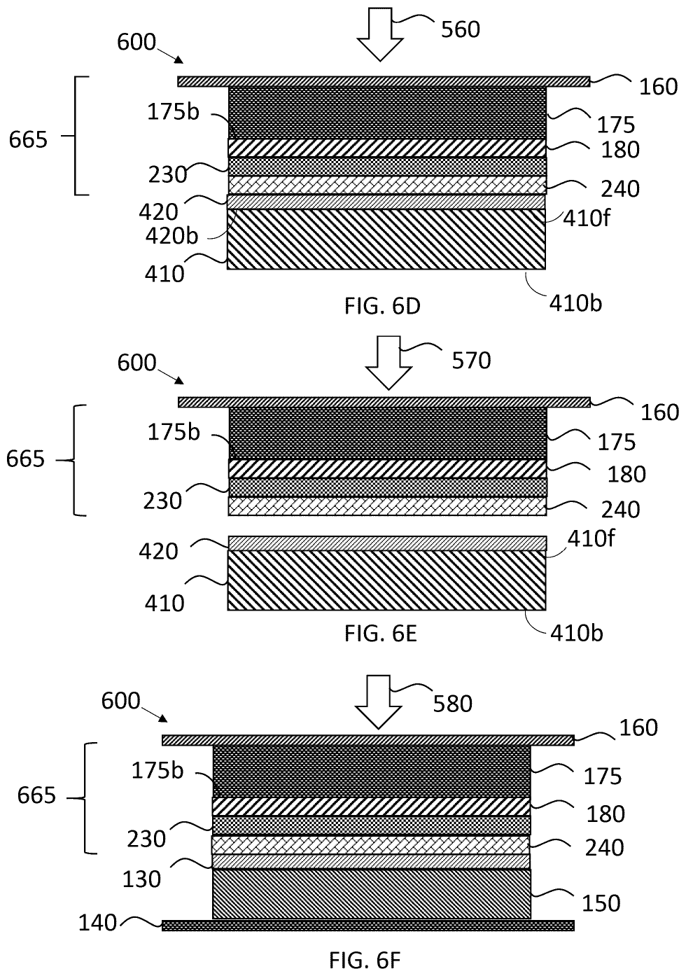

FIG. 5 illustrates a flow chart of a method 500 for manufacturing an energy storage device in accordance with one or more implementations of the present disclosure. FIGS. 6A-6F illustrate views of various stages of manufacturing an energy storage device in accordance with one or more implementations of the present disclosure. Although FIGS. 6A-6F are described in relation to the method 500, it will be appreciated that the structures disclosed in FIGS. 6A-6F are not limited to the method 500, but instead may stand alone as structures independent of the method 500. Similarly, although the method 500 is described in relation to FIGS. 6A-6F, it will be appreciated that the method 500 is not limited to the structures disclosed in FIGS. 6A-6F but instead may stand alone independent of the structures disclosed in FIGS. 6A-6F. It should be understood that FIGS. 6A-6F illustrate only partial schematic views of the energy storage device structure 600, and the energy storage device structure 600 may contain any number of additional layer and/or additional materials common to energy storage devices, which are not shown for the sake of brevity. It should also be noted that although the method 500 illustrated in FIG. 5 is described sequentially, other process sequences that include one or more operations that have been omitted and/or added, and/or have been rearranged in another desirable order, fall within the scope of the implementations of the disclosure provided herein.

The method 500 is similar to the method 300 except that the method 500 includes forming an interface film 240 and a solid electrolyte interface film 230 over the carrier substrate 410 prior to formation of the plating and stripping enhancement film 180.

Referring to FIG. 6A, at operation 510, a carrier substrate 410 is provided. The carrier substrate 410 may have a release film 420 formed thereon as described at operation 320.

Referring to FIG. 6B, at operation 520, an interface film 240 is formed over the release film 420. The interface film 240 is formed over or on the release film 420 (if present) or the flexible carrier substrate 410. The interface film 240 is disposed between the release film 420 and the subsequently deposited SEI film 230. The interface film 240 may be deposited under vacuum or atmospheric conditions. The interface film 240 may be deposited using vacuum-coating techniques or atmospheric (atmospheric) coating techniques. The interface film 240 may be deposited under vacuum in a roll-to-roll deposition system. The interface film 240 may be deposited by vapor deposition techniques, for example, chemical vapor deposition (CVD), atomic layer deposition (ALD), physical vapor deposition (PVD), such as thermal evaporation or sputtering.

A ny suitable process may be used to form the interface film 240 on the frontside 220f of the release film 420. The interface film 240 may be deposited using atmospheric coating techniques. In one or more implementations, the interface film 240 may be formed using atmospheric coating techniques. Suitable coating techniques include, but are not limited to, a slot-die coating process, a doctor-blade coating process, a three-dimensional (3D) printing process, or a combination thereof. In one or more alternative implementations, the interface film 240 may be formed using vacuum coating techniques.

Referring to FIG. 6B, at operation 530, an SEI film 230 is formed over or on the interface film 240. The SEI film 230 is disposed between the interface film 240 and the subsequently deposited plating and stripping enhancement film 180. The SEI film 230 may be deposited using vacuum coating techniques. In one or more implementations, the SEI film 230 may be formed using atmospheric coating techniques. Suitable coating techniques include, but are not limited to, a slot-die coating process, a doctor-blade coating process, a three-dimensional (3D) printing process, or a combination thereof. In one or more alternative implementations, the SEI film 230 may be formed using vacuum coating techniques.

Referring to FIG. 6B, at operation 540, a plating a stripping enhancement film 180 is formed over or on the SEI film 230. The plating a stripping enhancement film 180 is disposed between the SEI film 230 and the subsequently deposited alkali metal-containing film 175. The plating a stripping enhancement film 180 may be deposited using atmospheric coating techniques. In one or more implementations, the plating a stripping enhancement film 180 may be formed using vacuum coating techniques or atmospheric coating techniques.

Referring to FIG. 6C, at operation 550, the alkali metal-containing film 175 is formed over or on the plating and stripping enhancement film 180. The alkali metal-containing film 175 may be formed as described in operation 340. The interface layer, 240, the SEI film 230, the plating and stripping enhancement film 180, and the alkali metal-containing film 175 form an SIDT film stack 655. Although the SIDT film stack 655 is shown as excluding the release film 420, the SIDT film stack 655 may or may not include the release film 420.

Referring to FIG. 6D, at operation 560, the SIDT film stack 655 is transferred from the carrier substrate 410 to the anode current collector 160 to form an anode film stack 665. The transfer process includes applying the anode current collector 160 to the frontside 175f of the alkali metal-containing film 175 during operation 560 followed by removal of the carrier substrate 410 and optionally the release film 420 from the plating and stripping enhancement film 180 to form the anode film stack 665 at operation 570. Transferring the SIDT film stack 655 from the carrier substrate 410 to the anode current collector 160 may include a lamination transfer process, a laser lift-off process, or both a lamination transfer process and a laser lift-off process as described in operation 350.

Referring to FIG. 6E, at operation 570, the carrier substrate 410 is removed or peeled away from the anode film stack 665. In one or more implementations, which can be combined with other implementations, during operation 570 the release film 420 remains or partially remains on the carrier substrate 410 after operation 570 as is shown in FIG. 6E. Alternatively, in other implementations, the release film 420 is transferred or partially transferred with the anode film stack 665.

Optionally, at operation 580, the anode film stack 665 may be subjected to a post-treatment process. The post-treatment process can be performed to activate the alkali metal containing layer, to accelerate absorption of the alkali metal, for example, lithium, into the plating and stripping enhancement layer, or a combination of both. The post-treatment process of operation 580 may be performed prior to removal of the carrier substrate at operation 570, during removal of the carrier substrate at operation 570, or subsequent to removal of the carrier substrate at operation 570. The post-treatment process can be performed as described at operation 370.

Referring to FIG. 6F, at operation 590, the anode film stack 665 may be subject to additional processing. For example, the anode film stack 665 may be integrated with one or more of the cathode electrode structure 120 and the separator film 130 to form an energy storage device, such as the energy storage device structure 600 shown in FIG. 6F.

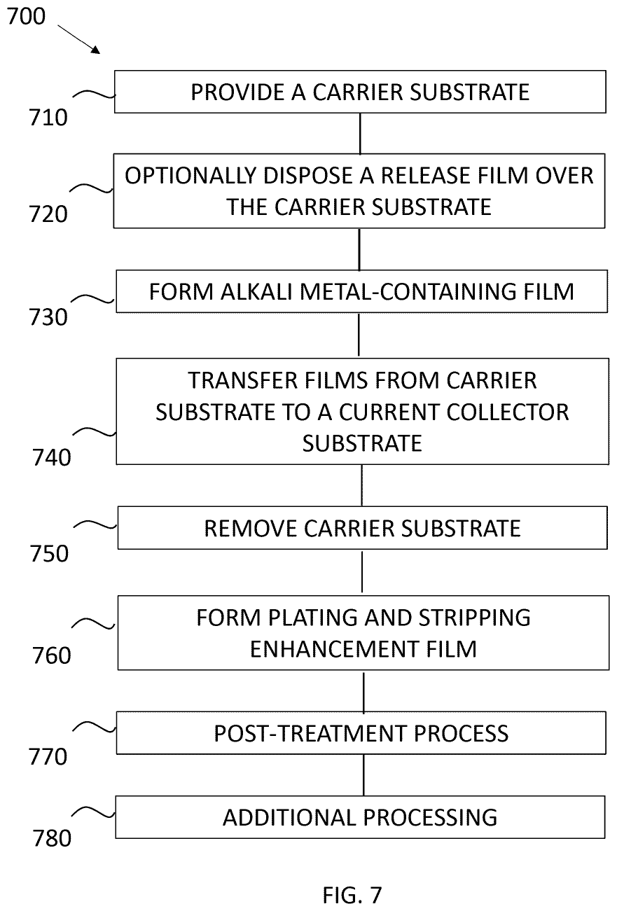

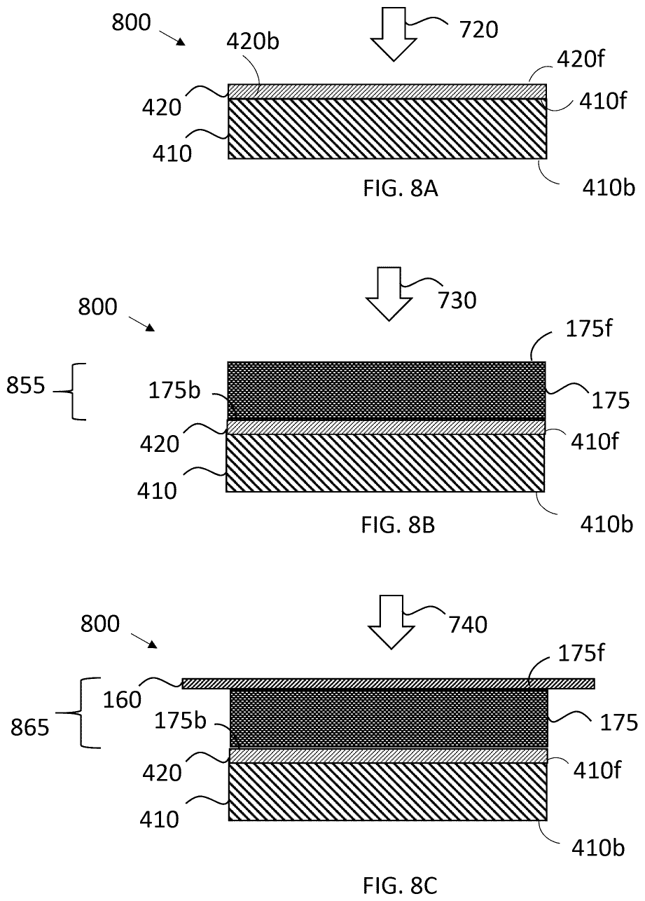

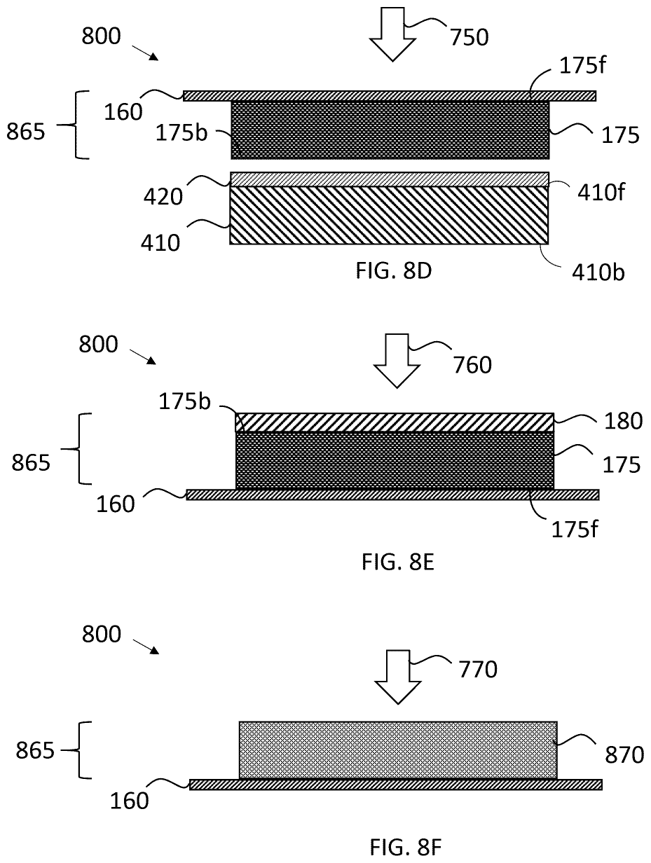

FIG. 7 illustrates a flowchart showing selected operations of another method 700 of forming an energy storage device structure 800 incorporating a plating and stripping enhancement film or particle coating in accordance with one or more implementations of the present disclosure. FIGS. 8A-8F illustrate views of various stages of manufacturing an energy storage device according to the method 700 of FIG. 7 in accordance with one or more implementations of the present disclosure. Although FIGS. 8A-8F are described in relation to the method 700, it will be appreciated that the structures disclosed in FIGS. 8A-8F are not limited to the method 700, but instead may stand alone as structures independent of the method 700. Similarly, although the method 700 is described in relation to FIGS. 8A-8F, it will be appreciated that the method 700 is not limited to the structures disclosed in FIGS. 8A-8F but instead may stand alone independent of the structures disclosed in FIGS. 8A-8F. It should be understood that FIGS. 8A-8F illustrate only partial schematic views of the energy storage device structure 800, and the energy storage device structure 800 may contain any number of additional layer and/or additional materials common to energy storage devices, which are not shown for the sake of brevity. It should also be noted that although the method 700 illustrated in FIG. 7 is described sequentially, other process sequences that include one or more operations that have been omitted and/or added, and/or have been rearranged in another desirable order, fall within the scope of the implementations of the disclosure provided herein.

Referring to FIG. 8A, at operation 710, a carrier substrate 410 is provided. Optionally, at operation 720, the carrier substrate 410 may have a release film 420 formed thereon. The release layer may be formed as described at operation 320.

Referring to FIG. 8B, at operation 730, an alkali metal-containing film 175 is formed over the carrier substrate 410. The alkali metal-containing film 175 includes a frontside 175f (also referred to as a front surface) and a backside 175b (also referred to as a back surface) opposite the frontside 175f. The alkali metal-containing film 175 may be formed on the carrier substrate 410 or on the release film 420 (if present). The alkali metal-containing film 175 may be or include lithium. The alkali metal-containing film 175 may be formed as described in operation 340. The alkali metal-containing film 175 may be part of an SIDT film stack 855. Although the SIDT film stack 855 is shown as excluding the release film 420, the SIDT film stack 855 may or may not include the release film 420.

Referring to FIG. 8C, at operation 740, the SIDT film stack 855 is transferred from the carrier substrate 410 to the anode current collector 160 to form an anode film stack 865. The transfer process includes applying the anode current collector 160 to the frontside 175f of the alkali metal-containing film 175 during operation 740 followed by removal of the carrier substrate 410 and optionally the release film 420 from the alkali metal-containing film 175 to form the anode film stack 865 at operation 750. Transferring the SIDT film stack 855 from the carrier substrate 410 to the anode current collector 160 may include a lamination transfer process, a laser lift-off process, or both a lamination transfer process and a laser lift-off process as described in operation 350.

Referring to FIG. 8D, at operation 750, the carrier substrate 410 is removed or peeled away from the anode film stack 865. In one or more implementations, which can be combined with other implementations, during operation 750 the release film 420 remains or partially remains on the carrier substrate 410 after operation 750 as is shown in FIG. 8D. Alternatively, in other implementations, the release film 420 is transferred or partially transferred with the anode film stack 865.

Referring to FIG. 8E, at operation 760, the plating and stripping enhancement film 180 is formed over or on the alkali metal-containing film 175. The plating and stripping enhancement film 180 may be deposited under vacuum or atmospheric conditions. The plating and stripping enhancement film 180 may be deposited as described in operation 330.

In one or more implementations as is shown in FIG. 8E, the plating and stripping enhancement film 180 is applied to the backside 175b of the alkali metal-containing film 175.

Referring to FIG. 8F, at operation 770, the anode film stack 865 may be subjected to a post-treatment process. The post-treatment process of operation 770 can be performed to activate the alkali metal-containing film 175, to accelerate absorption of the alkali metal, for example, lithium, from the alkali metal-containing film 175 into the plating and stripping enhancement film 180, or a combination of both. The post-treatment process of operation 770 may increase the rate of intercalation of the plating and stripping enhancement film 180 and the alkali metal-containing film 175 form an anode film 870 including an alloy of the material of the alkali metal-containing film 175 and the material of the plating and stripping enhancement film 180 as shown in FIG. 8F. The post-treatment process of operation 770 can be performed as described at operation 370.

Optionally at operation 780, the anode film stack 865 may be subject to additional processing. For example, the anode film stack 865 may be integrated with one or more of the cathode electrode structure 120 and the separator film 130 to form an energy storage device, similar to the energy storage device 610 shown in FIG. 6F.

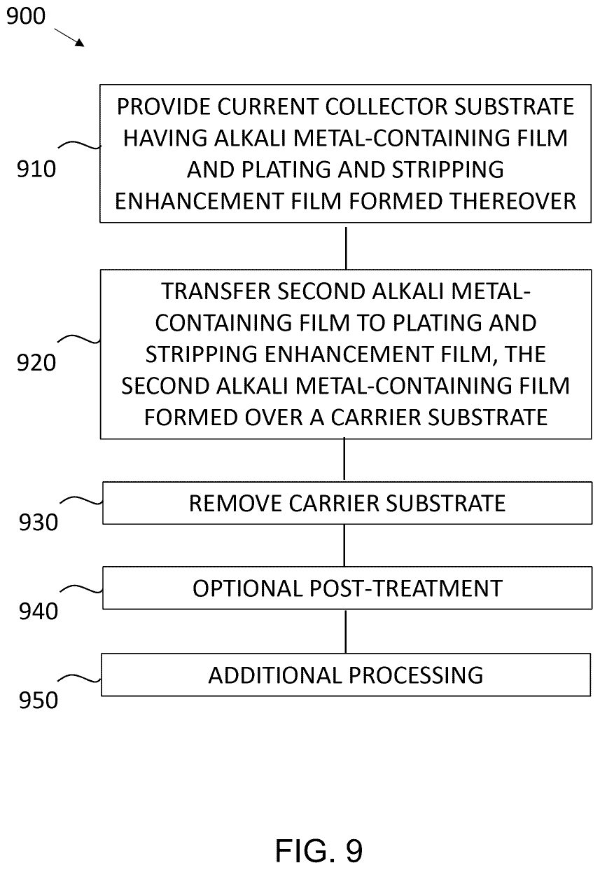

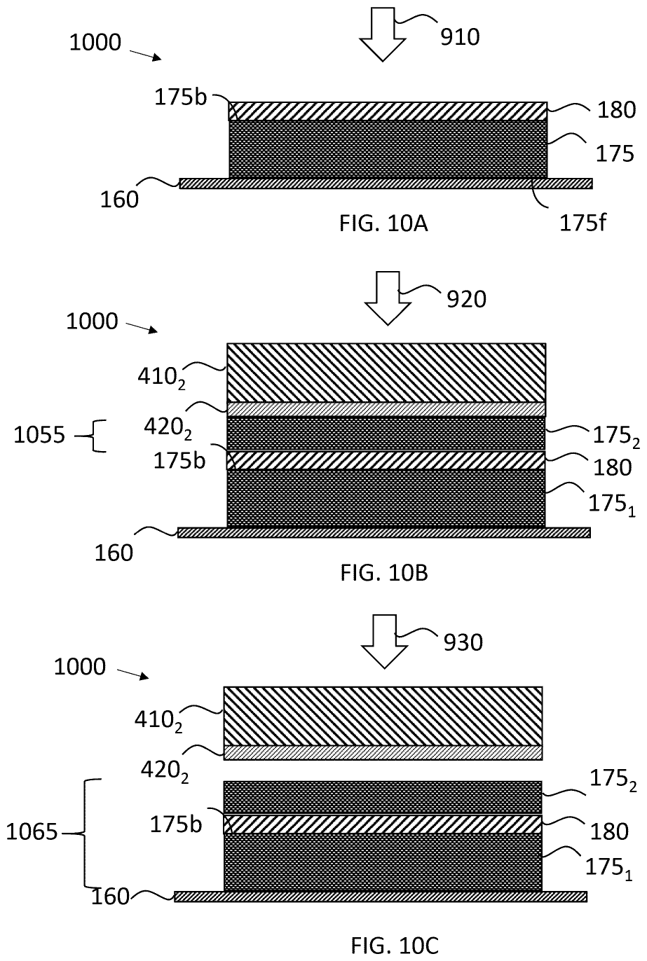

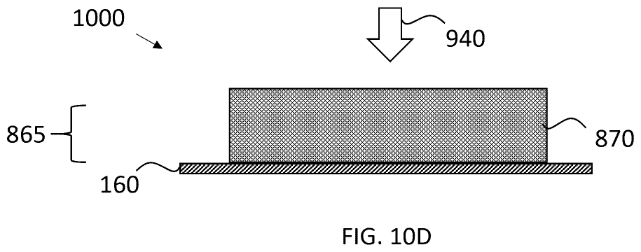

FIG. 9 illustrates a flowchart showing selected operations of another method 900 of forming an energy storage device incorporating a plating and stripping enhancement film in accordance with one or more implementations of the present disclosure. FIGS. 10A-10D illustrate views of various stages of manufacturing an energy storage device according to the method 900 of FIG. 9 in accordance with one or more implementations of the present disclosure. Although FIGS. 10A-10D are described in relation to the method 900, it will be appreciated that the structures disclosed in FIGS. 10A-10D are not limited to the method 900, but instead may stand alone as structures independent of the method 900. Similarly, although the method 900 is described in relation to FIGS. 10A-10D, it will be appreciated that the method 900 is not limited to the structures disclosed in FIGS. 10A-10D but instead may stand alone independent of the structures disclosed in FIGS. 10A-10D. It should be understood that FIGS. 10A-10D illustrate only partial schematic views of the energy storage device structure 1000, and the energy storage device structure 1000 may contain any number of additional layer and/or additional materials common to energy storage devices, which are not shown for the sake of brevity. It should also be noted that although the method 900 illustrated in FIG. 9 is described sequentially, other process sequences that include one or more operations that have been omitted and/or added, and/or have been rearranged in another desirable order, fall within the scope of the implementations of the disclosure provided herein.

The method 900 may be performed as part of any of the methods 300, 500, and 700. For example, the method 900 may be performed in lieu of or as part of the optional post-treatment or additional processing operations of the methods 300, 500, and 700. The method 900 includes a second SIDT process to form a second layer of alkali metal-containing film over or on the plating and stripping enhancement film 180. During the second SIDT process, the plating and stripping enhancement film 180 or particle coating is compressed between the first alkali metal-containing film and the second alkali metal-containing film of form an anode film, which is an alloy of the alkali metal-containing material and the material of the plating and stripping enhancement layer.

Referring to FIG. 10A, at operation 910 a device structure 1000 is provided. The device structure 1000 includes a current collector 160 having a first alkali metal-containing film 1751 formed thereon. The device structure 1000 further includes a plating and stripping enhancement film 180 formed over or on the first alkali metal-containing film 1751. The device structure 1000 may be formed by a transfer process or SIDT process as described herein where the first alkali metal-containing film 1751 is transferred onto the current collector 160. The plating and stripping enhancement film 180 may be transferred along with the first alkali metal-containing film 1751 or subsequently deposited on the first alkali metal-containing film 1751 after the first alkali metal-containing film 1751 is transferred onto the current collector 160.

Referring to FIG. 10B, at operation 920, a second SIDT film stack 1055 including a second alkali metal-containing film 1752 is transferred onto the exposed surface of the plating and stripping enhancement film 180 to form the anode film stack 1065. The second alkali metal-containing film 1752 is formed over or on a second carrier substrate 4102 with an optional release film 4202 formed in between the second alkali metal-containing film 1752 and the second carrier substrate 4102. The transfer process may be an SIDT process as described. During the second SIDT process, the plating and stripping enhancement film 180 may be compressed between the first alkali metal-containing film 1751 and the second alkali metal-containing film 1752. This compression may form an alloy of the alkali metal-containing material and the material of the plating and stripping enhancement layer.

Referring to FIG. 10C, at operation 930, the second carrier substrate 4102 is removed or peeled away from the anode film stack 1065. In one or more implementations, which can be combined with other implementations, during operation 930 the release film 4202 remains or partially remains on the second carrier substrate 4102 after operation 930 as is shown in FIG. 10C. Alternatively, in other implementations, the release film 4202 is transferred or partially transferred with the anode film stack 1065.

Optionally at operation 940, the device structure 1000 may be subjected to a post-treatment process. The post-treatment process may be as described herein.

Optionally at operation 950, the device structure 1000 may be subjected to additional processing as described herein.

FIG. 11 illustrates a schematic side view of a lamination transfer system 1100 in accordance with one or more implementations of the present disclosure. The lamination transfer system 1100 includes equipment for transferring SIDT film stacks, for example, the SIDT film stacks 455, 655, 855 and 1055, including lithium films on a first flexible carrier 1110, for example, the carrier substrate 410, and a second flexible carrier 1120, for example the carrier substrate 410, to each side of a flexible substrate 1130, for example, the anode current collector 160, so that the flexible substrate 1130 with the lithium films can be used as an electrode (e.g., anode) in an energy storage device, for example, a lithium-ion battery. The lamination transfer system 1100 includes a calendering unit 1140 to transfer the SIDT film stacks on the flexible carriers 1110, 1120 to the flexible substrate 1130.

The lamination transfer system 1100 includes a first flexible carrier supply hub 1115. A supply roll 1111 of the first flexible carrier 1110 is positioned on the first flexible carrier supply hub 1115. In some embodiments, the first flexible carrier 1110 includes the carrier substrate 410 having the SIDT film stack 455, 655, 855, 1055 disposed thereon as is shown in FIG. 4D, FIG. 6C, FIG. 8B, and FIG. 10B respectively. An SIDT film stack including a lithium film (not shown in FIG. 11) is positioned on the lower side 1110L of the first flexible carrier 1110, so that this lithium film faces an upper surface 1130U of the flexible substrate 1130 as the first flexible carrier 1110 and the flexible substrate 1130 are conveyed through the calendering unit 1140. The lithium film may be the alkali metal-containing film 175. The upper surface 1130U of the flexible substrate 1130 is on an opposite side relative to a lower surface 1130L of the flexible substrate 1130. The upper surface 1130U is also referred to as the first surface or the first side of the flexible substrate 1130 while the lower surface is also referred to as the second surface or the second side of the flexible substrate 1130.

The lamination transfer system 1100 includes a second flexible carrier supply hub 1125. A supply roll 1121 of the second flexible carrier 1120 is positioned on the second flexible carrier supply hub 1125. In some embodiments, the second flexible carrier 1120 can be formed of a same material (e.g., PET) as the first flexible carrier 1110. An SIDT film stack including a lithium film (not shown in FIG. 11), for example, any of the SIDT film stacks 455, 655, 855, is positioned on the upper side 1120U of the second flexible carrier 1120, so that this lithium film faces the lower surface 1130L of the flexible substrate 1130 as the second flexible carrier 1120 and the flexible substrate 1130 are conveyed through the calendering unit 1140.

The lamination transfer system 1100 includes a flexible substrate supply hub 1135. A supply roll 1131 of the flexible substrate 1130 is positioned on the flexible substrate supply hub 1135. In some embodiments, the flexible substrate 1130 can be formed of one or more of copper, graphite, silicon, silicon graphite, silicon oxide graphite, silicon, metalized plastic, or other materials.

The lamination transfer system 1100 further includes the calendering unit 1140. The calendering unit 1140 includes a first calender roller 1141 and a second calender roller 1142. The first flexible carrier 1110, the second flexible carrier 1120, and the flexible substrate 1130 are arranged to be conveyed along a path that extends between the first calender roller 1141 and the second calender roller 1142. The flexible substrate 1130 is positioned between the first flexible carrier 1110 and the second flexible carrier 1120 when the first flexible carrier 1110, the second flexible carrier 1120, and the flexible substrate 1130 are conveyed between the first calender roller 1141 and the second calender roller 1142. The calender rollers 1141, 1142 exert a high amount of pressure on the flexible carriers 1110, 1120 and the flexible substrate 1130 that causes the SIDT film stack on each of the flexible carriers 1110, 1120 to be transferred to the flexible substrate 1130. In some embodiments, a release layer, for example, the release film 420, is disposed on each of the flexible carriers 1110, 1120 between the corresponding flexible carrier 1110, 1120 and the SIDT film stack on that flexible carrier.

The lamination transfer system 1100 includes a first flexible carrier pickup hub 1116. A pickup roll 1112 of the first flexible carrier 1110 is positioned on the first flexible carrier pickup hub 1116. The SIDT film stack is no longer on the first flexible carrier 1110 when the first flexible carrier 1110 is wound onto the first flexible carrier pickup hub 1116 because the SIDT film stack previously on the first flexible carrier 1110 is transferred onto the flexible substrate 1130 by the calendering unit 1140.

The lamination transfer system 1100 includes a second flexible carrier pickup hub 1126. A pickup roll 1122 of the second flexible carrier 1120 is positioned on the second flexible carrier pickup hub 1126. The SIDT film stack is no longer on the second flexible carrier 1120 when the second flexible carrier 1120 is wound onto the second flexible carrier pickup hub 1126 because the SIDT film stack previously on the second flexible carrier 1120 is transferred onto the flexible substrate 1130 by the calendering unit 1140.

The lamination transfer system 1100 includes a flexible substrate pickup hub 1136. A pickup roll 1132 of the flexible substrate 1130 is positioned on the flexible substrate pickup hub 1136. The flexible substrate 1130 includes an SIDT film stack on each of the upper surface 1130U and the lower surface 1130L of the flexible substrate 1130. The SIDT film stacks are transferred from the respective flexible carriers 1110, 1120 onto the flexible substrate 1130 by the calendering unit 1140.

The lamination transfer system 1100 further includes a plurality of rollers 1181-1188. In some embodiments, each of the rollers 1181-1188 can be passive rollers. The rollers 1181-1188 can assist in applying proper tension to and assist in changing the direction of the flexible carriers 1110, 1120 and the flexible substrate 1130 during the movement of each of the flexible carriers 1110, 1120 and the flexible substrate 1130 through the different portions of the lamination transfer system 1100. Some of the rollers 1181-1188 can also assist in moving the flexible carriers 1110, 1120 closer to or further away from the flexible substrate 1130. For example, the second and third rollers 1182, 1183 assist in bringing the flexible carriers 1110, 1120 into contact with the flexible substrate 1130 before the flexible carriers 1110, 1120 and the flexible substrate 1130 are conveyed through the calendering unit 1140. Additionally, the fourth and fifth rollers 1184, 1185 provide a location at which tension can be applied to the flexible carriers 1110, 1120 to peel the flexible carriers 1110, 1120 away from the flexible substrate 1130. After peeling the flexible carriers 1110, 1120 away from the flexible substrate 1130, the flexible carriers 1110, 1120 travel over the sixth and seventh rollers 1186, 1187 to the respective flexible carrier pickup hubs 1116, 1126. In some embodiments, one or more of the rollers 1181-1188 can instead be a bar, such as metal bar, that can apply tension to the carrier or flexible substrate during the movement of the carrier or flexible substrate.

The lamination transfer system 1100 can further include actuators (not shown) configured to rotate each of the hubs 1115, 1116, 1125, 1126, 1135, 1136, so that the flexible carriers 1110, 1120 and the flexible substrate 1130 can be conveyed from the corresponding supply hub 1115, 1125, 1135, through the calendering unit 1140, and to the corresponding pick hub 1116, 1126, 1136. The lamination transfer system 1100 can further include one or more actuators (not shown) to rotate the calender rollers 1141, 1142 of the calendering unit 1140. The rotational speed of the actuators can be adjusted to control the speed at which the flexible substrate 1130 and flexible carriers 1110, 1120 are conveyed through the lamination transfer system 1100.

In the lamination transfer system 1100, the flexible substrate 1130 is conveyed along a path from the supply roll 1131 that is supported by the supply hub 1135, past the first roller 1181, between the second and third rollers 1182, 1183, between the calender rollers 1141, 1142, between the fourth and fifth rollers 1184, 1185, past the eighth roller 1188, and to the pickup roll 1132 around the pickup hub 1136. The pickup hub 1136 is configured to rotate and assist in conveying the flexible substrate along the path after the flexible substrate 1130 passes between the first calender roller 1141 and the second calender roller 1142. Similarly, the pickup hubs 1116, 1126 are configured to rotate and assist in conveying the flexible carriers along paths between the supply hubs 1115, 1125 and the pickup hubs 1116, 1126.

The lamination transfer system 1100 can also include a controller 1105 for controlling processes performed by the lamination transfer system 1100. The controller 1105 can be any type of controller used in an industrial setting, such as a programmable logic controller (PLC). The controller 1105 includes a processor 1107, a memory 1106, and input/output (I/O) circuits 1108. The controller 1105 can further include one or more of the following components (not shown), such as one or more power supplies, clocks, communication components (e.g., network interface card), and user interfaces typically found in controllers for semiconductor equipment.

The memory 1106 can include non-transitory memory. The non-transitory memory can be used to store the programs and settings described below. The memory 1106 can include one or more readily available types of memory, such as read only memory (ROM) (e.g., electrically erasable programmable read-only memory (EEPROM), flash memory, floppy disk, hard disk, or random access memory (RAM) (e.g., non-volatile random access memory (NVRAM).

The processor 1107 is configured to execute various programs stored in the memory 1106, such as a program configured to execute the methods 300, 500, 700, 900 as described. During execution of these programs, the controller 1105 can communicate to I/O devices through the I/O circuits 1108. For example, during execution of these programs and communication through the I/O circuits 1108, the controller 1105 can control outputs (e.g., the actuators connected to the different hubs and the calendering unit 1140). The memory 1106 can further include various operational settings used to control the lamination transfer system 1100. For example, the settings can include speed settings for the actuators connected to the hubs.

In one or more implementations, the controller 1105 is configured to cause the lamination transfer system 1100 to perform a process including conveying a film stack from a supply hub toward a pickup hub, the film stack comprising a flexible carrier substrate, a plating and stripping enhancement layer formed over the flexible carrier substrate, an alkali metal-containing layer formed on the plating and stripping enhancement layer, wherein the plating and stripping enhancement layer comprises a constriction compliant material. The process further includes contacting the film stack with a flexible conductive substrate, laminating the film stack to the flexible conductive substrate, and removing the flexible carrier substrate from the film stack.

The previously described implementations of the present disclosure have many advantages including the following. Benefits of the present disclosure include longer cycling alkali metal/alloy anode battery and fast charge capability. SIDT manufacturing path is appropriate for the device stack and can enable faster commercialization for high volume manufacturing. However, the present disclosure does not necessitate that all the advantageous features and all the advantages need to be incorporated into every implementation of the present disclosure.

In the Summary and in the Detailed Description, and the Claims, and in the accompanying drawings, reference is made to particular features (including method operations) of the present disclosure. It is to be understood that the disclosure in this specification includes all possible combinations of such particular features. For example, where a particular feature is disclosed in the context of a particular aspect, implementation, implementation, or example of the present disclosure, or a particular claim, that feature can also be used, to the extent possible in combination with and/or in the context of other particular aspects and implementations of the present disclosure, and in the present disclosure generally.

Implementations and all of the functional operations described in this specification can be implemented in digital electronic circuitry, or in computer software, firmware, or hardware, including the structural means disclosed in this specification and structural equivalents thereof, or in combinations of them. Implementations described herein can be implemented as one or more non-transitory computer program products, i.e., one or more computer programs tangibly embodied in a machine readable storage device, for execution by, or to control the operation of, data processing apparatus, e.g., a programmable processor, a computer, or multiple processors or computers.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an A SIC (application specific integrated circuit).

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. Processors suitable for the execution of a computer program include, by way of example, both general and special purpose microprocessors, and any one or more processors of any kind of digital computer.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The term “comprises” and grammatical equivalents thereof are used herein to mean that other components, ingredients, operations, etc. are optionally present. For example, an article “comprising” (or “which comprises”) components A, B, and C can consist of (i.e., contain only) components A, B, and C, or can contain not only components A, B, and C but also one or more other components. In addition, whenever a composition, an element or a group of elements is preceded with the transitional phrase “comprising” or grammatical equivalents thereof, it is understood that it is contemplated that the same composition or group of elements may be preceded with transitional phrases “consisting essentially of,” “consisting of,” “selected from the group of consisting of,” or “is” preceding the recitation of the composition, element, or elements and vice versa.

Where reference is made herein to a method comprising two or more defined operations, the defined operations can be carried out in any order or simultaneously (except where the context excludes that possibility), and the method can include one or more other operations which are carried out before any of the defined operations, between two of the defined operations, or after all of the defined operations (except where the context excludes that possibility).

When introducing elements of the present disclosure or exemplary aspects or implementation(s) thereof, the articles “a,” “an,” “the” and “said” are intended to mean that there are one or more of the elements.

While the foregoing is directed to implementations of the present disclosure, other and further implementations of the disclosure may be devised without departing from the basic scope thereof, and the scope thereof is determined by the claims that follow.

What is claimed is:

1. A method of making an electrode structure, comprising:
forming a film stack over a carrier substrate, comprising:
forming a plating and stripping enhancement film over the carrier substrate, the plating and stripping enhancement film comprising a constriction compliant material; and
forming an alkali metal-containing film on the plating and stripping enhancement film; and
transferring the film stack from the carrier substrate to a flexible conductive substrate to form an anode film stack, wherein the alkali metal-containing film contacts the flexible conductive substrate in the anode film stack.

2. The method of claim 1, wherein the constriction compliant material is selected from oxides of Mg, oxides of aluminum, oxides of silicon, Ag, Al, Bi, Mg, Sn, Zn, Cu, Si, alloys of Ag, Al, Bi, Mg, Zn, Cu, Sn, Si, silica coated Ag, silica coated Bi, silica coated Mg, silica coated Sn, or a combination thereof.

3. The method of claim 2, wherein the alkali metal-containing film is a lithium metal film.

4. The method of claim 1, further comprising:
a release film formed on the carrier substrate, the release film contacting the carrier substrate and the plating and stripping enhancement film.

5. The method of claim 1 further comprising:
forming an interface film over the carrier substrate; and
forming a solid electrolyte film on the interface film, the interface film and the solid electrolyte film formed prior to the plating and stripping enhancement film.

6. The method of claim 5, wherein the interface film, the solid electrolyte film, and the plating and stripping enhancement film are formed using non-vacuum coating techniques.

7. The method of claim 6, wherein the alkali metal-containing film is formed using vacuum coating techniques.

8. The method of claim 1, wherein the carrier substrate comprises a material selected from polyethylene terephthalate (PET), polyethylene naphthalate (PEN), polyimide (PI), metallized plastic, or a combination thereof.

9. The method of claim 1, wherein transferring the film stack from the carrier substrate to the flexible conductive substrate comprises a lamination transfer process, a laser lift-off process, or both the lamination transfer process and the laser lift-off process.

10. The method of claim 5, wherein the interface films comprises a material selected from lithium fluoride, lithium chloride, lithium iodide, lithium oxide, lithium sulfide, lithium nitride, lithium phosphide, or a combination thereof.

11. The method of claim 10, wherein the solid electrolyte film comprises a solid electrolyte selected from lithium super ionic CONductor (LISICON), lithium aluminum germanium phosphate (LAGP), lithium aluminum titanium phosphate (LATP), lithium lanthanum titanium oxide (LLTO), lithium lanthanum zirconium oxide (LLZO), lithium phosphorous oxynitride (LiPON), Li7P2S8I, Li6PS5Cl, Li3PS4 (LPS), Li3.5Ge0.25PS4, Li10GeP2S12 (LGPS), or a combination thereof.

12. An alkali metal-containing film stack, comprising:
a flexible carrier substrate; and
a film stack formed over the flexible carrier substrate, the film stack comprising:
a plating and stripping enhancement film formed over the flexible carrier substrate, the plating and stripping enhancement film comprising a constriction compliant material; and
an alkali metal-containing film formed on the plating and stripping enhancement film.

13. The alkali metal-containing film stack of claim 12, wherein the constriction compliant material is selected from oxides of Mg, oxides of aluminum, oxides of silicon, Ag, Al, Bi, Mg, Zn, Cu, Sn, Si, alloys of Ag, Al, Bi, Mg, Zn, Cu, Sn, Si, silica coated Ag, silica coated Bi, silica coated Mg, silica coated Sn, or a combination thereof.

14. The alkali metal-containing film stack of claim 13, wherein the alkali metal-containing film is a lithium metal film.

15. The alkali metal-containing film stack of claim 13, further comprising:
a release film formed on the flexible carrier substrate, the release film contacting the flexible carrier substrate and the plating and stripping enhancement film.

16. The alkali metal-containing film stack of claim 12, wherein the film stack further comprises
a solid electrolyte film formed over the flexible carrier substrate; and
an interface film formed on the solid electrolyte film, the alkali metal-containing film formed on the interface film.

17. The alkali metal-containing film stack of claim 16, wherein the flexible carrier substrate comprises a material selected from polyethylene terephthalate (PET), polyethylene naphthalate (PEN), polyimide (PI), metallized plastic, or a combination thereof.

18. The alkali metal-containing film stack of claim 17, wherein the interface film comprises a material selected from lithium fluoride, lithium chloride, lithium iodide, lithium oxide, lithium sulfide, lithium nitride, lithium phosphide, or a combination thereof.

19. The alkali metal-containing film stack of claim 18, wherein the solid electrolyte comprises a solid electrolyte selected from lithium super ionic CON ductor (LISICON), lithium aluminum germanium phosphate (LA GP), lithium aluminum titanium phosphate (LATP), lithium lanthanum titanium oxide (LLTO), lithium lanthanum zirconium oxide (LLZO), lithium phosphorous oxynitride (LiPON), Li7P2S8I, Li6PS5Cl, Li3PS4 (LPS), Li3.5Ge0.25PS4, Li10GeP2S12 (LGPS), or a combination thereof.

20. A lamination transfer system, comprising:
a lamination transfer chamber; and
a system controller configured to cause the lamination transfer chamber to perform a process, comprising:
conveying a film stack from a supply hub toward a pickup hub, the film stack comprising a flexible carrier substrate, a plating and stripping enhancement film formed over the flexible carrier substrate, an alkali metal-containing film formed on the plating and stripping enhancement film, wherein the plating and stripping enhancement film comprises a constriction compliant material;
contacting the film stack with a flexible conductive substrate;
laminating the film stack to the flexible conductive substrate; and
removing the flexible carrier substrate from the film stack.
